(19) United States
(12) Patent Application Publication
(10) Pub. No.: US 2024/0185305 A1
(43) Pub. Date: Jun. 6, 2024

(54) Artificial Intelligence Audience Generation System and Method

(71) Applicant: Supernatural Development, LLC, San Francisco, CA (US)

(72) Inventors: Mike Barrett, San Anselmo, MA (US); John Elder, San Francisco, CA (US); Paul Caiozzo, Spokane, WA (US); Lucas Shuman, Portland, OR (US)

(21) Appl. No.: 18/527,068

(22) Filed: Dec. 1, 2023

Related U.S. Application Data
(60) Provisional application No. 63/429,622, filed on Dec. 2, 2022.

(51) Int. Cl. G06Q 30/0241; G06F 40/40; G06Q 30/0242

(52) U.S. Cl. CPC G06Q 30/0276; G06F 40/40; G06Q 30/0242

(57) ABSTRACT

A system includes at least one processor to execute computer-readable instructions to ingest data from at least one third party data source associated with determining an artificial intelligence audience, receive a response to each question associated with determining the artificial intelligence audience, generate a prompt based on the response to each question and transmit the prompt to a large language model (LLM) application programming interface (API), generate the artificial intelligence audience based on the response to each question and the LLM API, and transmit at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience.

### CROSS-REFERENCE TO RELATED APPLICATIONS

This application claims priority under 35 U.S.C. § 119 to U.S. Patent Application No. 63/429,622, filed Dec. 2, 2022 entitled “Automated Advertisement Generation System and Method,” the entire contents of which is incorporated herein by reference.

### BACKGROUND

Creative advertising is problematic for those that make ads, the clients that purchase ads from ad agencies, and consumers that are forced to view messaging that is not relevant. Year after year, more is spent on advertising. However, ad awareness continues to steadily decrease. This is likely because of the proliferation of ad messages. The average adult is exposed to 2,000 ad messages a day and yet is unable to recall more than one or two. Despite technological improvements in ad targeting, there has not been a way to systematically improve relevance.

It is with these issues in mind, among others, that various aspects of the disclosure were conceived.

### SUMMARY

The present disclosure is directed to an automated, artificial intelligence audience generation system and method. The system may include a client computing device that communicates with a server computing device to generate an artificial intelligence (AI) audience. The AI audience may be determined based on a number of answers to questions as well as data from a number of sources.

In one example, a system may include a memory storing computer-readable instructions and at least one processor to execute the instructions to ingest data from at least one third party data source associated with determining an artificial intelligence audience, transmit at least one question associated with determining the artificial intelligence audience, receive a response to each question associated with determining the artificial intelligence audience, analyze each response to each question associated with determining the artificial intelligence audience, generate a prompt based on the response to each question and transmit the prompt to a large language model (LLM) application programming interface (API), receive a response from the LLM API, generate the artificial intelligence audience based on the response to each question and the LLM API, and transmit information associated with the artificial intelligence audience, the information comprising at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience.

In another example, a method may include ingesting, by at least one processor, data from at least one third party data source associated with determining an artificial intelligence audience, transmitting, by the at least one processor, at least one question associated with determining the artificial intelligence audience, receiving, by the at least one processor, a response to each question associated with determining the artificial intelligence audience, analyzing, by the at least one processor, each response to each question associated with determining the artificial intelligence audience, generating, by the at least one processor, a prompt based on the response to each question and transmitting the prompt to a large language model (LLM) application programming interface (API), receiving, by the at least one processor, a response from the LLM API, generating, by the at least one processor, the artificial intelligence audience based on the response to each question and the LLM API, and transmitting, by the at least one processor, information associated with the artificial intelligence audience, the information comprising at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience.

In another example, a non-transitory computer-readable storage medium may have instructions stored thereon that, when executed by a computing device cause the computing device to perform operations, the operations including ingesting data from at least one third party data source associated with determining an artificial intelligence audience, transmitting at least one question associated with determining the artificial intelligence audience, receiving a response to each question associated with determining the artificial intelligence audience, analyzing each response to each question associated with determining the artificial intelligence audience, generating a prompt based on the response to each question and transmitting the prompt to a large language model (LLM) application programming interface (API), receiving a response from the LLM API, generating the artificial intelligence audience based on the response to each question and the LLM API, and transmitting information associated with the artificial intelligence audience, the information comprising at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of an artificial intelligence audience generation (AIAG) system according to an example of the instant disclosure.

FIG. 2 is another block diagram of the artificial intelligence audience generation system according to an example of the instant disclosure.

FIG. 3 shows a block diagram of a server computing device of the artificial intelligence audience generation system having an artificial intelligence audience generation application according to an example of the instant disclosure.

FIG. 4 is a flowchart of a method of generating an artificial intelligence audience according to an example of the instant disclosure.

FIGS. 5-37 show screenshots of an example user interface of the artificial intelligence audience generation application according to an example of the instant disclosure.

FIGS. 38A and 38B show an example user interface of an example artificially generated audience member according to an example of the instant disclosure.

FIGS. 39A and 39B show an example user interface showing demographic information associated with the artificially generated audience member according to an example of the instant disclosure.

FIGS. 40A and 40B show another example user interface showing demographic information and personality information associated with the artificially generated audience member according to an example of the instant disclosure.

FIG. 41 shows example images and music generated by the artificial intelligence audience generation application according to an example of the instant disclosure.

FIG. 42 shows an example script generated by the artificial intelligence audience generation application according to an example of the instant disclosure.

FIG. 43 shows example social media posts generated by the artificial intelligence audience generation application according to an example of the instant disclosure.

FIGS. 44A and 44B show a user interface used to generate social media posts according to an example of the instant disclosure.

FIG. 45 shows artificial intelligence evaluation according to an example of the instant disclosure.

FIG. 46 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Aspects of an artificial intelligence audience generation system and method includes a client computing device that communicates with a server computing device to generate an artificial intelligence audience. The artificial intelligence audience may be determined based on a number of answers to questions as well as data from a number of sources.

In one example, a system may include a memory storing computer-readable instructions and at least one processor to execute the instructions to ingest data from at least one third party data source associated with determining an artificial intelligence audience, transmit at least one question associated with determining the artificial intelligence audience, receive a response to each question associated with determining the artificial intelligence audience, analyze each response to each question associated with determining the artificial intelligence audience, generate a prompt based on the response to each question and transmit the prompt to a large language model (LLM) application programming interface (API), receive a response from the LLM API, generate the artificial intelligence audience based on the response to each question and the LLM API, and transmit information associated with the artificial intelligence audience, the information comprising at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience.

Creative advertising is problematic for those that make ads, the clients that buy ads from ad agencies, and consumers that are forced to view messaging that is not relevant. Year after year, more is spent on advertising. However, ad awareness continues to steadily decrease. This is likely because of the proliferation of ad messages. The average adult is exposed to 2,000 ad messages a day and yet is unable to recall more than one. Despite technological improvements in ad targeting, there has not been a way to systematically improve relevance based on target audience insights data. At the same time, there is downward pressure on client fees and upward pressure on salaries with less time for creating advertising, and yet creative advertising has been resistant to changing the way they work. Today ads get made much the same way they were during the MadMen era sixty years ago. The system utilizes artificial intelligence and a computing system that generates an artificial intelligence audience and recommendations. The artificial intelligence audience may have a number of members and each example member may have a voice and an opinion. Each example member of the audience can be questioned and provide responses to questions based on generative personality and demographics. The member of the audience may have an image and can voice their opinion via audio and textual output. Conventionally, advertisements have been manually generated. The system herein utilizes computing devices to generate recommendations in fractions of the time that may have taken days to produce. Additionally, the system provides consistency because the system considers every possible strategy.

In one example, the system may obtain data from different data sources such as third party data sources in areas including demographic data, search data, and social sensing data. This may allow the system to drive consistency and precision when developing audience insights. This standardizes the totality of information gathered and is trackable over time. Without this solution, there is inconsistency in the sources and types of data pulled together, which is usually based on individual strategist habits. Further, the most well-respected advertising effectiveness research has been ingested and passed through the system so the audience insights plus client data leads to a set of strategies known to be effective. The sources of data include leading industry research regarding advertising effectiveness including research from the Advertising Research Foundation, World Advertising Research Council, The Cannes Effectiveness ladder, and other sources such as YouGov having a dataset associated with over 347,000 individuals and information from 5,000 surveys a week, providing robust and current information. These sources are used by the system to provide recommendations in real-time. The data ingested may include data from clients or agencies as well as third-party sources. The data may describe information associated with an audience for a brand, how purchase decisions are made in a category, what brands are considered for purchase decisions, relative strength of competing brands relative to one another, development state of a client brand, and objectives for a piece of work (e.g., awareness, sales). The system can determine a precise understanding of a target audience and may provide a consistent way of working through client information that can lead to relevant communications for consumers and greater effectiveness for advertisers. In addition, the system greatly accelerates many of the manual processes involved in strategy research, with greater accuracy, allowing a significant time-savings on the part of the advertising creators.

As a result, the system utilizes the data and provides recommendations and an artificial intelligence audience based on twenty-five years of aggregated knowledge that drives advertising effectiveness including academic research, industry experience, and prior results associated with previous campaigns. Based on inputs and analysis, strategy candidates and an artificial intelligence audience are provided to a user.

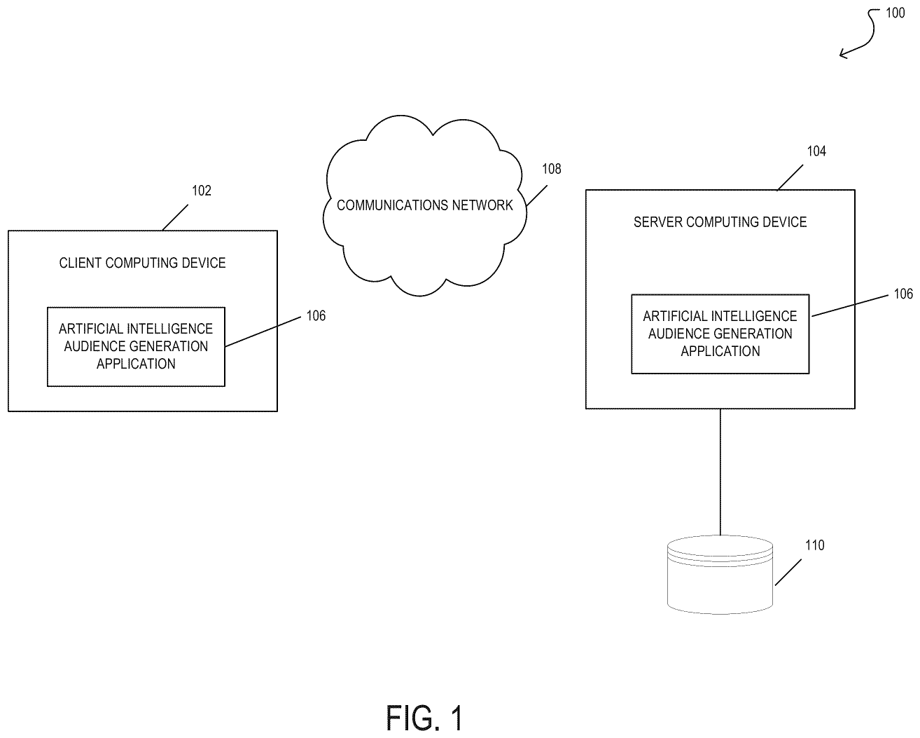

FIG. 1 is a block diagram of an artificial intelligence audience generation (AIAG) system 100 according to an example of the instant disclosure. As shown in FIG. 1, the system 100 may include at least one client computing device 102 and at least one server computing device 104. The at least one server computing device 104 may be in communication with at least one database 110.

The client computing device 102 and the server computing device 104 may have an artificial intelligence audience generation application 106 that may be a component of an application and/or service executable by the at least one client computing device 102 and/or the server computing device 104. For example, the artificial intelligence audience generation application 106 may be a single unit of deployable executable code or a plurality of units of deployable executable code. According to one aspect, the artificial intelligence audience generation application 106 may include one component that may be a web application, a native application, and/or an application (e.g., an app) downloaded from a digital distribution application platform that allows users to browse and download applications developed with software development kits (SDKs) including the APPLE® iOS App Store and GOOGLE PLAY®, among others.

The artificial intelligence audience generation system 100 also may include one or more data sources that store and communicate data from at least one database 110. The data stored in the at least one database 110 may be associated with users and the one or more third party data sources. As an example, the database may store one or more strategy engine sessions associated with each user. Additionally, the database may store information associated with one or more rulesets for artificial intelligence audience generation and information associated with artificial intelligence (AI) copywriter generation.

The at least one client computing device 102 and the at least one server computing device 104 may be configured to receive data from and/or transmit data through a communication network 108. Although the client computing device 102 and the server computing device 104 are shown as a single computing device, it is contemplated each computing device may include multiple computing devices.

The communication network 108 can be the Internet, an intranet, or another wired or wireless communication network. For example, the communication network 108 may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a near field communication (NFC) network, a satellite communications network, or an IEEE 802.11 standards network, as well as various communications thereof. Other conventional and/or later developed wired and wireless networks may also be used.

The client computing device 102 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the client computing device 102 further includes at least one communications interface to transmit and receive communications, messages, and/or signals.

The client computing device 102 could be a programmable logic controller, a programmable controller, a laptop computer, a smartphone, a personal digital assistant, a tablet computer, a standard personal computer, or another processing device. The client computing device 102 may include a display, such as a computer monitor, for displaying data and/or graphical user interfaces. The client computing device 102 may also include a Global Positioning System (GPS) hardware device for determining a particular location, an input device, such as one or more cameras or imaging devices, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

The server computing device 104 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the server computing device 104 further includes at least one communications interface to transmit and receive communications, messages, and/or signals.

As an example, the client computing device 102 and the server computing device 104 communicate data in packets, messages, or other communications using a common protocol, e.g., Hypertext Transfer Protocol (HTTP) and/or Hypertext Transfer Protocol Secure (HTTPS). The one or more computing devices may communicate based on representational state transfer (REST) and/or Simple Object Access Protocol (SOAP). As an example, a first computer (e.g., the client computing device 102) may send a request message that is a REST and/or a SOAP request formatted using Javascript Object Notation (JSON) and/or Extensible Markup Language (XML). In response to the request message, a second computer (e.g., the server computing device 104) may transmit a REST and/or SOAP response formatted using JSON and/or XML.

When users first use the artificial intelligence audience generation application 106, they may be asked to create an account associated with the system. As an example, a user may provide account information including name information, an email address, username information, and password information, among others. The account information and/or a representation of the account information may be stored in the database 110. In addition, when the user utilizes the strategy engine associated with the artificial intelligence audience generation application 106, a session and associated data may be stored in the database 110. Each session may be stored as a separate dataset based on answers provided to the questions.

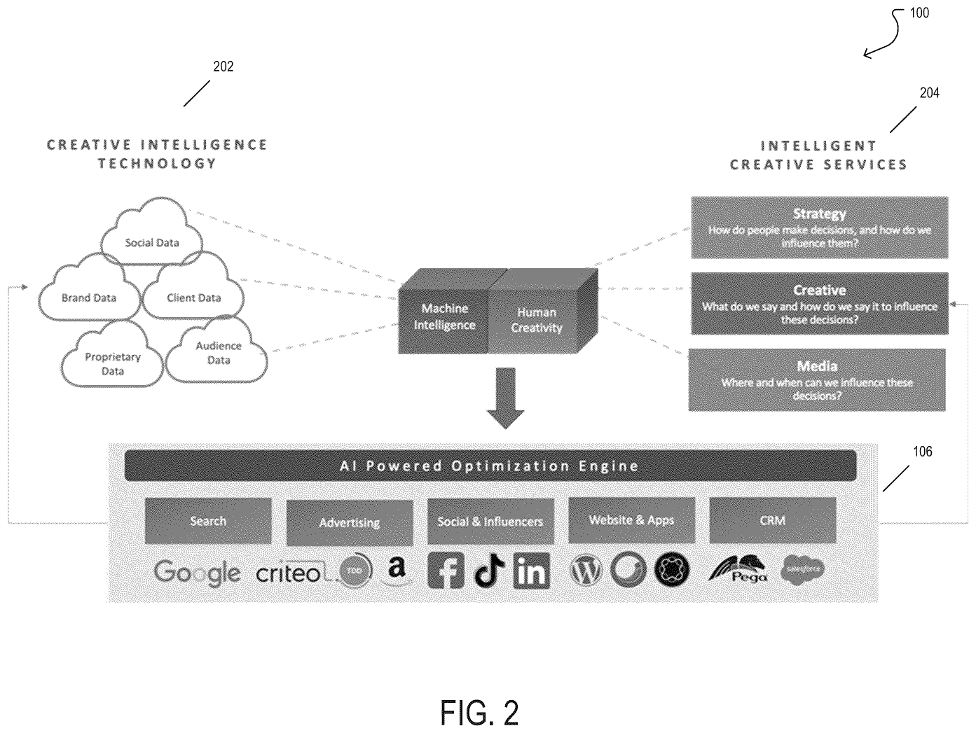

FIG. 2 shows another block diagram of the artificial intelligence audience generation system 100 according to an example of the instant disclosure. As shown in FIG. 2, the artificial intelligence audience generation system 100 may utilize creative intelligence technology 202 associated with social data, brand data, client data, proprietary data, and audience data as well as intelligent creative services 204 and may provide an artificial intelligence (AI) powered optimization engine as provided by the artificial intelligence audience generation application 106. The engine may be a strategy engine as well as a copywriter engine.

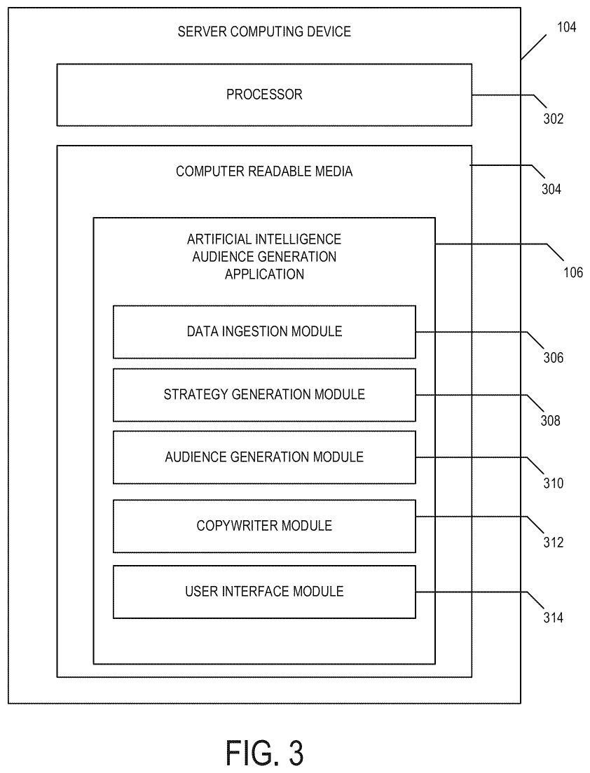

FIG. 3 is a block diagram of the artificial intelligence audience generation application 106 according to an example of the instant disclosure. The artificial intelligence audience generation application 106 may be executed by the server computing device 104. The server computing device 104 includes computer readable media (CRM) 304 in memory on which the artificial intelligence audience generation application 106 is stored. The computer readable media 304 may include volatile media, nonvolatile media, removable media, non-removable media, and/or another available medium that can be accessed by the processor 302. By way of example and not limitation, the computer readable media 304 comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

The artificial intelligence audience generation application 106 may include a data ingestion module 306 according to an example of the instant disclosure. As an example, the data ingestion module 306 may import data and information from one or more third party servers providing sources of data and information such as social data, brand data, brand index information including seventeen points of brand data for thousands of brands, client data, proprietary data, and audience data, among others. Each of the third party servers may have a web application programming interface (API) to send and receive responses to requests for data.

The artificial intelligence audience generation application 106 may include a strategy generation module 308, also known as a strategy engine, according to an example of the instant disclosure. As an example, the strategy generation module 308 allows a user to provide answers to a number of questions. The strategy generation module 308 may analyze each answer and determine whether a threshold criteria is met for at least two questions. If the threshold criteria is met for the at least two questions, the strategy or characteristic may be determined to be a candidate. The strategies or characteristics that may be selected as top strategies or characteristics may be based on a number of conditions that are met and a degree to which conditions met an ideal score for a particular strategy or characteristic. The recommended strategies or characteristics may be ordered based on a number of conditions that are met. A higher number of conditions may result in a higher ranking.

As an example, a strategy of badge driven may be a match because there were three different questions that had an answer with a score meeting a particular threshold criteria. In addition, influence driven may be a match because there were two different questions that had an answer that had a score meeting a particular threshold criteria. Badge driven would be ranked higher than influence driven because there were three questions with answers meeting the particular threshold criteria for badge driven and two different questions with answers that had a score meeting the particular threshold criteria for influence driven.

Further, safety driven may be a match because there were two different questions that had an answer with a score meeting a particular threshold criteria. In this case, because safety driven and influence driven were tied with two different questions meeting the particular threshold criteria, the strategy generation module 308 may compare the safety driven score with an ideal score and compare the influence driven score with an ideal score. The strategy generation module 308 may rank them based on a variance from the ideal score.

In one example, for each strategy, the strategy generation module 308 may compare each answer to each question with a ruleset. When the answer is within the particular threshold for two or more questions, the strategy may be selected as a match.

As an example, for influence driven, there are the following particular threshold criteria: answer is greater than or equal to 7 on quant_word_of_mouth, answer is laggard or challenger to quant_current_market_pos, or answer is greater than 6 to quant_kpi_consideration. Influence driven is associated with endorsement, it can be digitally and socially led, video oriented, heavy owned, brand oriented, and may be associated with lower cost purchases. There are considerations associated with potential for longer wear in, potential for lower brand attribution, and potential for higher cost.

For badge driven, there are the following particular threshold criteria: answer to quant_brand_differentiation is less than 5, answers to quant_kpi_awareness or quant_kpi_consideration is greater than 7, or answer to quant_current_market_pos is challenger, established player, or leader. Badge driven is associated with brand preference to drive purchase. Badge driven can be experience and video led and there may be cultural or tentpole tie ins. It may be associated with lower consideration categories such as beverages, liquor, beer, etc. The considerations may be that is may be hard to measure bottom line impact, and it can take time to wear in.

For fame driven, there are the following particular threshold criteria: answer to quant_audience_category_feels is greater than 7, answer to quant_cost_comparison is greater than 6, or answers to quant_kpi_awareness or quant_kpi_consideration is greater than 7. Fame driven may be associated with pricing power and/or may be competition with well established brands. Fame driven may be heavy video and celebrity endorsement led. Celebrities may be used. This may work well for apparel as well as new product launches. The considerations may be that it can be expensive and celebrities can be difficult to work with.

For competitively driven, there are the following particular threshold criteria: answer to quant_current_market_pos is challenger or established player, answer to quant_brand_differentiation is greater than 7, or answer to quant_kpi_shopping, quant_kpi_lead_gen, or quant_kpi_purchases is greater than 7. Competitively driven may be associated with a product advantage but competitors may be larger than you. It may be reach driven and claim led. There may be a superiority point that can matter to an audience. It can work well in hard-fought categories. However, there can be considerations such as generating scrutiny and triggering retaliation (that can be good).

For aspiration driven, there are the following particular threshold criteria: answer to quant_audience_purchase_frequency is less than 5, answer to quant_kpi_awareness or quant_kpi_consideration is greater than 7, or answer to quant_cost_comparison is greater than 6. Aspiration driven may be associated with needing pricing power. It can be visually led and emotionally driven. Visuals may inspire an emotional response. It can work in premium categories such as luxury automobile and high end apparel. However, there are considerations associated with high production costs and it can take time to wear in.

For future driven, there are the following particular threshold criteria: answer to quant_current_market_pos is challenger or established player, answer to quant_brand_differentiation is greater than 7, or answer to quant_ads_how_smart is greater than 6. For future driven, it can be for launching something new. It can be channel neutral and intelligence led. There may be a smarter take on an issue or a smarter solution to a problem. It can work well across categories. The considerations may include experience across touchpoints and may require constant innovation or shifting strategies as competitors catch up.

For brand and performance driven, there are the following particular threshold criteria: answer is greater than 5 at all but one of the following: quant_kpi_awareness, quant_kpi_consideration, and quant_kpi_purchases, answer is less than 6 for quant_brand_differentiationLow, and answer is less than 5 for quant_audience_category_feels. For brand and performance driven, advertising may be a primary business driver. It can be multichannel and focused on video, display, and site-side. It can work well in commodity or heavily regulated categories, e.g., insurance, banking. The considerations may be the expense and it may require a high degree of organizational commitment and alignment.

For advocacy driven, there are the following particular threshold criteria: answer is greater than 7 on any of the following: quant_kpi_shopping, quant_kpi_consideration, or quant_kpi_purchases, answer is middling or high for audience_purchase_involvement, and answer is less than 5 for quant_audience_category_feels. For advocacy driven, it may be for taking on a category that consumers dislike. Multichannel including video, social, and owned media may be useful. It can work in high avoidance categories such as financial advisory and health care. However, there are considerations associated with obtaining too much attention and there may be social/customer service management to address.

For value driven, there are the following particular threshold criteria: answer to quant_cost_comparison is less expensive or much less expensive, answer is greater than 7 on any of the following: quant_kpi_shopping, quant_kpi_consideration, or quant_kpi_purchases, and answer is greater than 7 on any of the following: quant_ads_how_humorous, quant_ads_how_edgy, or quant_ads_how_fun. For value driven, it can be associated with stealing share. It can utilize video, digital, and out of home. It can work well in lower consideration categories such as retail. However, there are considerations such as a low barrier to competitive response and it can attract lower value customers.

For safety driven, there are the following particular threshold criteria: answer to quant_current_market_pos is leader or laggard, answer to quant_audience_purchase_involvement is middling or high, or answer to quant_ads_how_sincere is greater than 7. Safety driven can be associated with protecting share. It can be channel agnostic and can lend itself to longer form content/channels. Safety driven may be useful in high consideration, well established categories such as automobiles and insurance. However, there are considerations associated with lack of excitement and a heavy burden of proof.

For barrier removal driven, there are the following particular threshold criteria: answer to quant_audience_category_feels is less than 5, answer to quant_brand_perception is greater than 7, and answer to quant_audience_purchase_involvement is middling or high. Barrier removal driven may be associated with bringing new customers into a brand. It can be channel agnostic and may lend itself to longer form content/channels. Barrier removal driven may be associated with high friction categories such as healthcare or automobile repair. There are considerations associated with placing a heavy burden on customer experience.

For authority driven, there are the following particular threshold criteria: answer to quant_current_market_poss is established player or leader, answer to quant_cost_comparison is more expensive or much more expensive, answers to quant_kpi_awareness or quant_kpi_consideration is greater than 7, and answers to quant_ads_how_smart or quant_ads_how_optimistic are greater than 7. Authority driven may be associated with driving brand preference. It can be video and partnership driven and it may utilize emotional stories that can be communicated through video. It can work in well-established categories for established brands. However, there are considerations associated with authenticity. If a brand cannot execute authentically, the strategy may not be effective.

For popularity driven, there are the following particular threshold criteria: answer to quant_audience_purchase_involvement is low, answer to quant_word_of_mouth is greater than 7, answer to quant_brand_differentiation is less than 5, and answers to quant_ads_how_humorous or quant_ads_how_fun is greater than 7. Popularity driven may be associated with driving impulse purchase. It can be video and endorsement driven. Popularity driven may work in low-involvement categories for established brands with low involvement purchases, e.g., sandwich shops. However, there may be considerations associated with the expense to execute and it may require staying topical/relevant.

For feature driven, there are the following particular threshold criteria: answer to quant_audience_purchase_involvement is high, answer to quant_brand_differentiation is greater than 7, and answer to quant_brand_perception is greater than 7. Feature driven may be associated with having a superiority point to emphasize. It can be channel agnostic and may utilize channels that can be used to demonstrate. It can work well in highly competitive, higher cost categories such as smartphones and hybrid vehicles. However, there are considerations associated with having a shorter shelf life than a brand driven strategy.

For product demonstration driven, there are the following particular threshold criteria: answer to quant_brand_differentiation is greater than 7 and answers to quant_kpi_lead_gen or quant_kpi_purchases is greater than 7. Product demonstration driven may be associated with introducing something new. Video and interactivity may be useful. It can work well for benefits that can be difficult to explain. However, there are considerations associated with generating interest unless the product is inherently interesting.

For character driven, there are the following particular threshold criteria: answer to quant_brand_differentiation is less than 5 and answer to quant_audience_category_feels is less than 5. Character driven may be associated with propositions that may need a lot of explanation. It can be video driven and may use dialogue to explain a proposition. It can work well for benefits that can be difficult to explain or that may not be relevant in the moment. However, there can be considerations associated with having organizational discipline and commitment.

For mnemonic driven, there are the following particular threshold criteria: answer to quant_brand_differentiation is less than 5, quant_word_of_mouth is greater than 7, and quant_audience_category_feels is less than 5. Mnemonic driven may be associated with low awareness and high competition. It can be video and visually driven. It can work well for challenger brands. However, message registration beyond the mnemonic can be difficult.

As an example, here are two rulesets for aspiration driven:

RULESET TYPE: ALL

Question ID or question tag: quant_cost_comparison

Rule range: 6-10

Test value: 3

Is match=FALSE

RULESET TYPE: ANY

Question ID: quant_kpi_awareness

Rule range: 7-10

Test value: 3

Is match=FALSE

Question ID: quant_kpi_consideration

Rule range: 7-10

Test value: 7

Is match=TRUE

In this case, only one ruleset is valid, so it is not a match.

The artificial intelligence audience generation application 106 may include an audience generation module 310 and may use the data from the data ingestion module 306 and the strategy generation module 308 to generate a prompt based on the response to each question and transmit the prompt to a large language model (LLM) application programming interface (API). In one example, the LLM API may be associated with a version of GPT such as ChatGPT (e.g., Chat Generative Pre-trained Transformer) using a version or model of GPT, among others such as Llama, Bard or GOOGLE AI, or Rytr. Additionally, the LLM API may be an image generation model such as DALL-E, Stable Diffusion, Midjourney, Dreambooth/LORA, among others. The artificial intelligence audience generation application 106 may receive a response from the LLM API and generate an artificial intelligence audience based on the response to each question and the LLM API. The artificial intelligence audience generation application 106 may transmit information associated with the artificial intelligence audience, the information comprising at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience.

In one example, the artificial intelligence generation application 106 may have one AI model for each user or may have one AI model that may be used by all users. The artificial intelligence generation application 106 can train image generation AI on user characters, products, and image styles. As an example, each user may have an image library and may train the image generation AI using their personalized image library. Additionally, the artificial intelligence generation application 106 may have text to voice over AI and may have keyframe animation generation using text to video.

The artificial intelligence audience generation application 106 may include a copywriter module 312 according to an example of the instant disclosure. As an example, a user may select a use case from a list of use cases including blog idea & outline, blog section writing, brand name, business idea pitch, business ideas, call to action, copywriting framework: AIDA (attract/attention, interest, desire, action), copywriting framework: PAS (problem, agitate, solution), email, FACEBOOK, TWITTER, LINKEDIN ads, GOOGLE search ads, interview questions, job description, landing page & website copies, magic command, post & caption ideas, product description, product description (bullet points), profile bio, question & answer, reply to reviews & messages, SEO meta description, SEO meta title, SMS & notifications, song lyrics, story plot, tagline & headline, testimonial & review, text editing: append content, text editing: continue writing, text editing: expand content, text editing: improve content, text editing: paragraph content, text editing: reword, text editing: shorten content, video channel description, and video idea. In addition, a user may provide primary text information. In one example, the user may be asked to provide one hundred characters or less of primary text information to be used by the copywriter module 312 as a starting point.

The user may select a particular tone such as one of appreciative, assertive, awestruck, candid, casual, cautionary, compassionate, convincing, critical, earnest, enthusiastic, formal, funny, humble, humorous, informative, inspirational, joyful, passionate, thoughtful, urgent, and worried. In addition, the user may indicate that the copywriter module 312 generate one or more variants and indicate a desired creativity level being one of optimal, none, low, medium, high, and maximum (e.g., less factual). Based on these selections and options, the copywriter module 312 may utilize the LLM API to generate one or more variants and display the one or more variants based on the primary text information.

The artificial intelligence audience generation application 106 may include a user interface module 314 according to an example of the instant disclosure. The user interface module 314 receives requests or other communications from the client computing device 102 and transmits a representation of requested information, user interface elements, and other data and communications to the client computing device 102 for display on the display. As an example, the user interface module 314 generates a native and/or web-based graphical user interface (GUI) that accepts input and provides output by generating content that is transmitted via the communications network 108 and viewed by a user of the client computing device 102. The user interface module 314 may provide realtime automatically and dynamically refreshed information to the user of the client computing device 102 using Java, Javascript, AJAX (Asynchronous Javascript and XML), ASP.NET, Microsoft .NET, and/or node.js, among others. The user interface module 314 may send data to other modules of the artificial intelligence audience generation application 106 of the server computing device 104, and retrieve data from other modules of the artificial intelligence audience generation application 106 of the server computing device 104 asynchronously without interfering with the display and behavior of the client computing device.

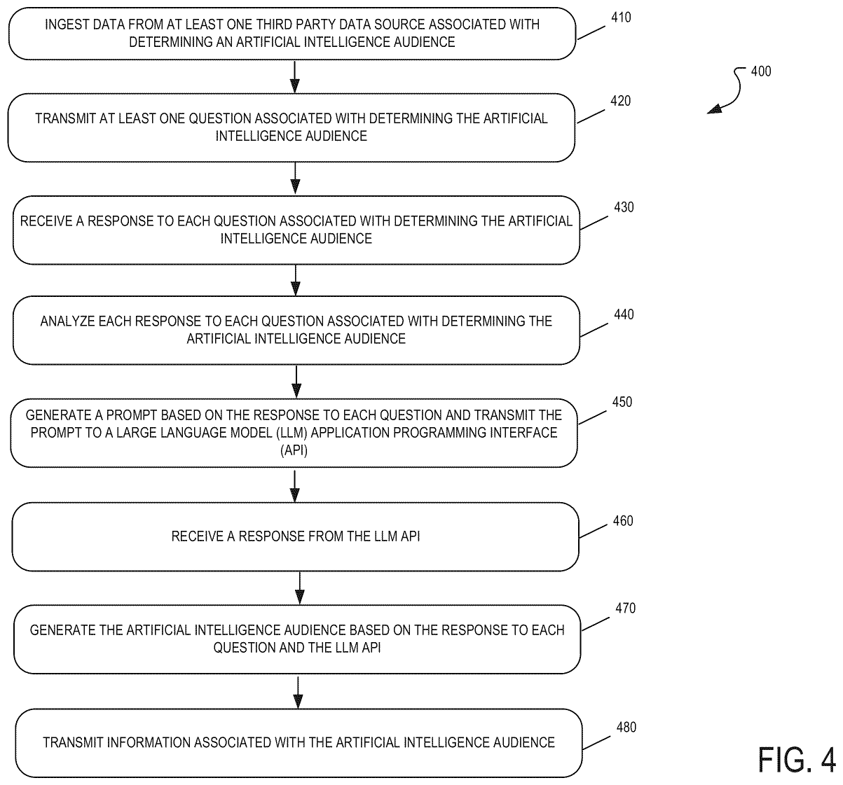

FIG. 4 illustrates an example method 400 of generating an artificial intelligence audience according to an example of the instant disclosure. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 may include ingesting data from at least one third party data source associated with determining an artificial intelligence (AI) audience at block 410.

Next, according to some examples, the method 400 may include transmitting or sending at least one question associated with determining the artificial intelligence audience at block 420. Example questions are shown below.

Next, according to some examples, the method 400 may include receiving a response to each question associated with determining the artificial intelligence audience at block 430. Example answers are shown below.

Next, according to some examples, the method 400 may include analyzing each response to each question associated with determining the artificial intelligence audience at block 440. The analyzing may include determining whether each answer is within a particular threshold criteria for each strategy and also determining a distance or value from an ideal score for each strategy within the particular threshold criteria.

Next, according to some examples, the method 400 may include generating a prompt based on the response to each question and transmitting the prompt a large language model (LLM) application programming interface (API) at block 450. As an example, the LLM API has access to data from at least one third party data source associated with determining the artificial intelligence audience comprising demographic data, search data, social sensing data, and advertising effectiveness research data, among others.

Next, according to some examples, the method 400 may include receiving a response from the LLM API at block 460.

Next, according to some examples, the method 400 may include generating the artificial intelligence audience based on the response to each question and the LLM API at block 470.

Next, according to some examples, the method 400 may include transmitting information associated with the artificial intelligence audience, the information comprising at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience at block 480.

As an example, the at artificial intelligence audience may be generated based on characteristics including character driven, mnemonic driven, brand and performance driven, popularity driven, barrier removal driven, future focused, value driven, defender, badge driven, product demonstration driven, influence driven, authority driven, aspirational, feature driven, competitive, fame driven, and advocacy driven, among others. A characteristic may be chosen as a potential match when the answer to at least two questions is within the particular threshold criteria for the characteristic.

In addition, the characteristic may be presented or displayed in a sorted order based on a number of questions having answers within the particular threshold criteria for the strategy. As an example, a first characteristic may have answers within the particular threshold criteria for four questions and it may be ranked as number one. As an example, a second characteristic may have answers within the particular threshold criteria for three questions and it may be ranked as number two. A third characteristic may have answers within the particular threshold criteria for two questions and it may be ranked as number three. A fourth characteristic may have answers within the particular threshold criteria for two questions and it may be ranked as number four because the ideal score distance is greater than the ideal score distance for number three.

According to some examples, the method 400 may include generating a graphical user interface (GUI) to receive the response to each question associated with determining the artificial intelligence audience.

According to some examples, the method 400 may include processing a ruleset associated with each of the characteristics, and determining whether the response to each question is within a particular range for each characteristic.

According to some examples, the method 400 may include determining that a rule for a ruleset associated with each of the characteristics is a match and determining that a respective ruleset is a match. In this case, for the ruleset that is a match, it may be determined that an answer is within a particular threshold criteria.

According to some examples, the method 400 may include determining a variance between an ideal score for a particular question associated with the artificial intelligence audience and the response to the particular question.

According to some examples, the method 400 may include receiving a request to skip one of the at least one question associated with determining the artificial intelligence audience.

According to some examples, the method 400 may include ordering the characteristics based on a number of matching rulesets associated with each of the characteristics.

According to some examples, the method 400 may include removing at least one characteristic having less than two matching rulesets associated with each of the characteristics.

According to some examples, the method 400 may include selecting six or fewer characteristics based on a number of matching rulesets associated with each of the characteristics.

According to some examples, the method 400 may include storing each response to each question in an artificial intelligence database, e.g., the database 110.

According to some examples, the method 400 may include generating an artificial intelligence engine based on the artificial intelligence database and the at least one third party data source. The artificial intelligence engine may learn based on the answers and provide more intelligent strategy recommendations in the future.

According to some examples, the method 400 may include generating the at least one generative image of a headshot of the member of the artificial intelligence audience.

According to some examples, the method 400 may include generating audio of the demographic information and outputting the audio of the demographic information as read by the member of the artificial intelligence audience having a particular voice associated with the response to each question.

According to some examples, the method 400 may include generating audio of the personality information and outputting the audio of the personality information as read by the member of the artificial intelligence audience.

According to some examples, the method 400 may include generating audio of a response to the input from the user and outputting the audio of the response to the input as read by the member of the artificial intelligence audience.

According to some examples, the method 400 may include generating a tone of voice (TOV) for the member of the artificial intelligence audience and using the TOV to generate the demographic information and the personality information.

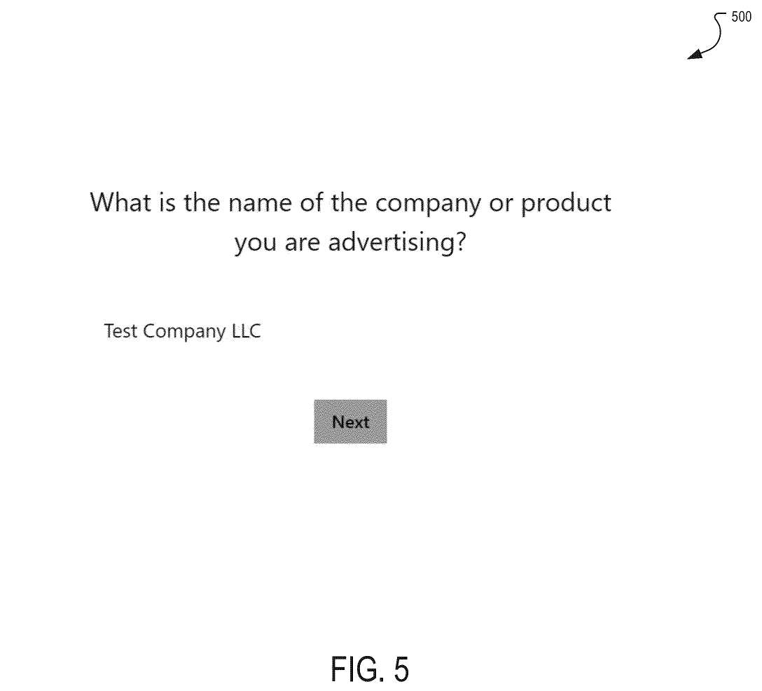

FIGS. 5 through 37 show screenshots of example graphical user interfaces (GUI) associated with the artificial intelligence audience application 106 according to an example of the instant disclosure. As shown in FIG. 5, the screenshot 500 shows that the artificial intelligence audience application 106 may send one or more questions to a user that may be using the client computing device 102 and the user may provide an answer to each question. As an example, a first question may be “What is the name of the company or product you are advertising?” A response may be “Test Company LLC” and the user may select a graphical user interface element such as the Next button to submit the response or answer to the question and move to a next question.

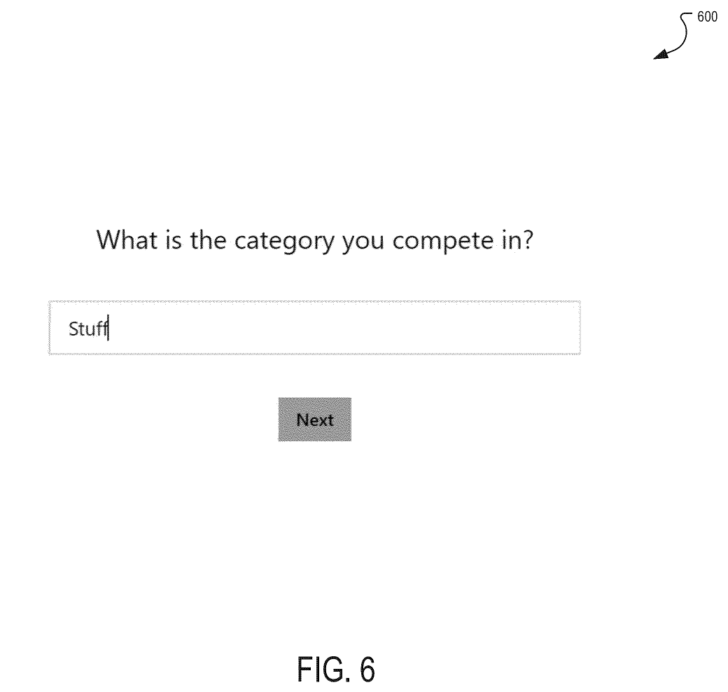

As shown in FIG. 6, the screenshot 600 shows another question, “What is the category you compete in?” The answer may be “Stuff” or “Healthcare” or “Automotive,” among others.

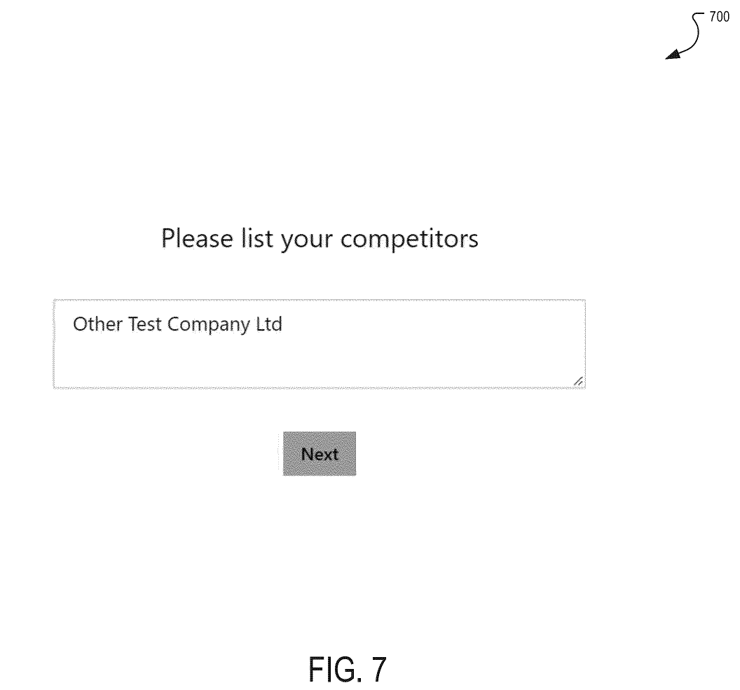

As shown in FIG. 7, the screenshot 700 shows another question, “Please list your competitors.” The answer may be “Other Test Company Ltd”.

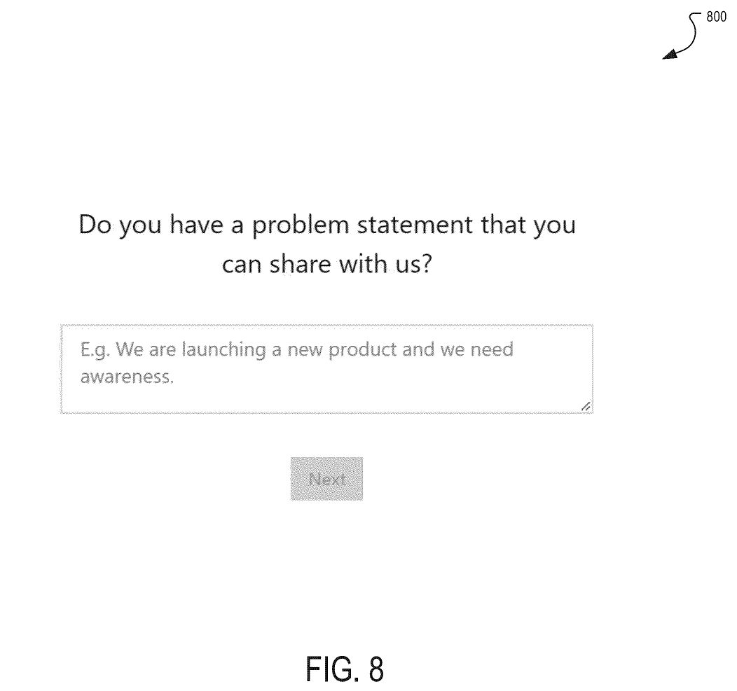

As shown in FIG. 8, the screenshot 800 shows another question, “Do you have a problem statement that you can share with us?” The answer may be “We are launching a new product and we need awareness.”

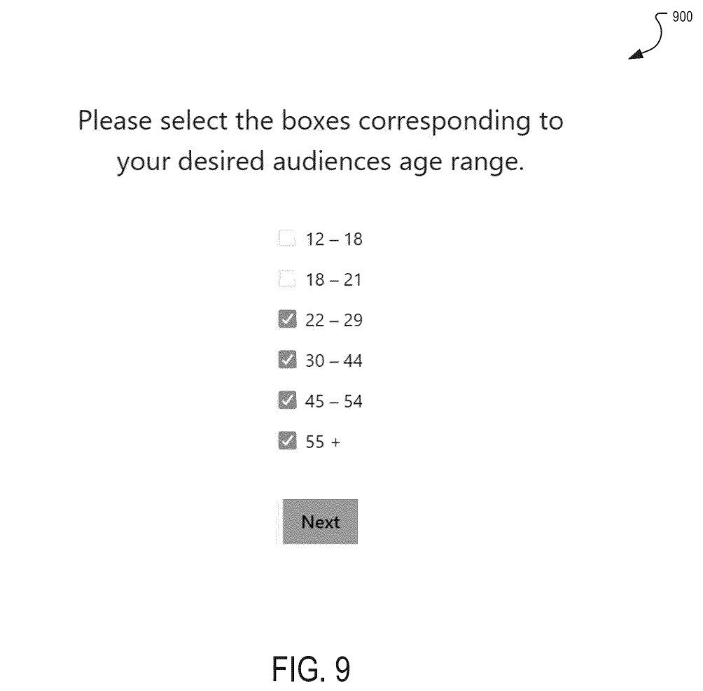

As shown in FIG. 9, the screenshot 900 shows another question, “Please select the boxes corresponding to your desired audiences age range.” The answer may be a selection of one or more age ranges.

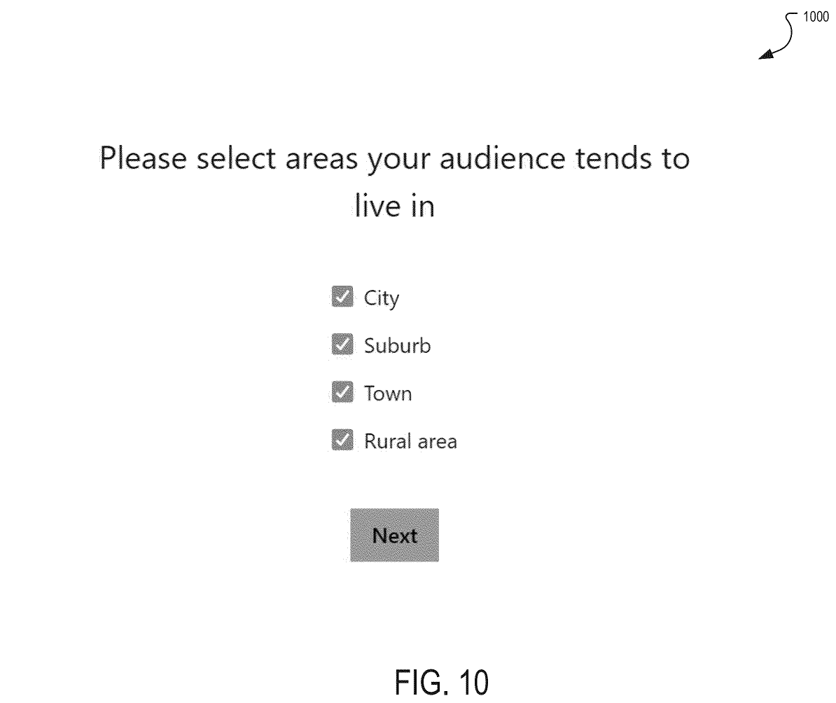

As shown in FIG. 10, the screenshot 1000 shows another question, “Please select areas your audience tends to live in”. The answer may be a selection of one or more areas.

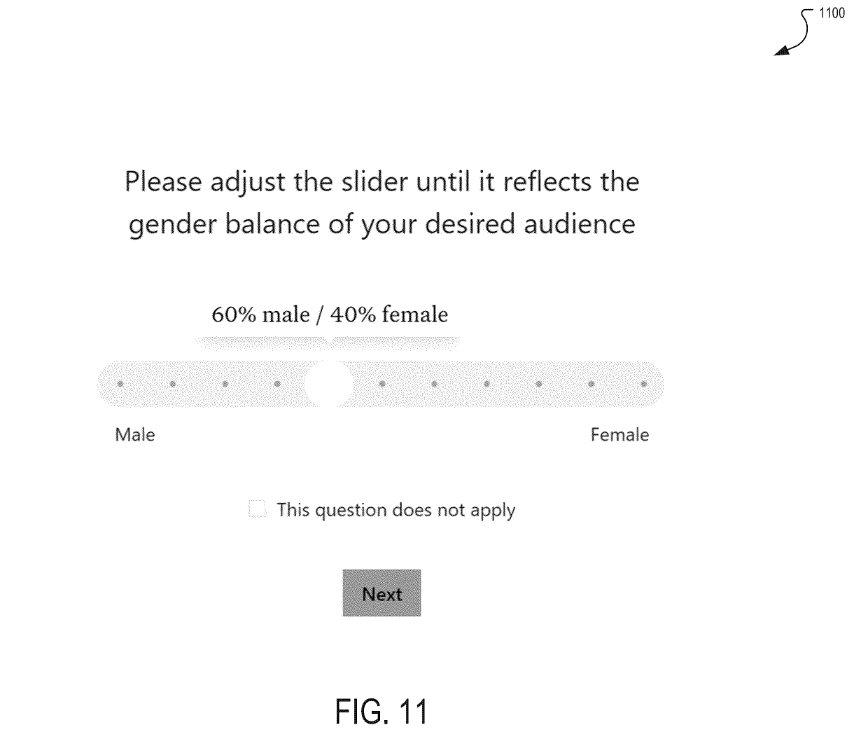

As shown in FIG. 11, the screenshot 1100 shows another question, “Please adjust the slider until it reflects the gender balance of your desired audience”. The answer may be a selection of the user interface element, e.g., the slider, that indicates the gender balance, which may be 50% male and 50% female or another percentage balance. Alternatively, the user can select a user interface element that indicates that the question does not apply.

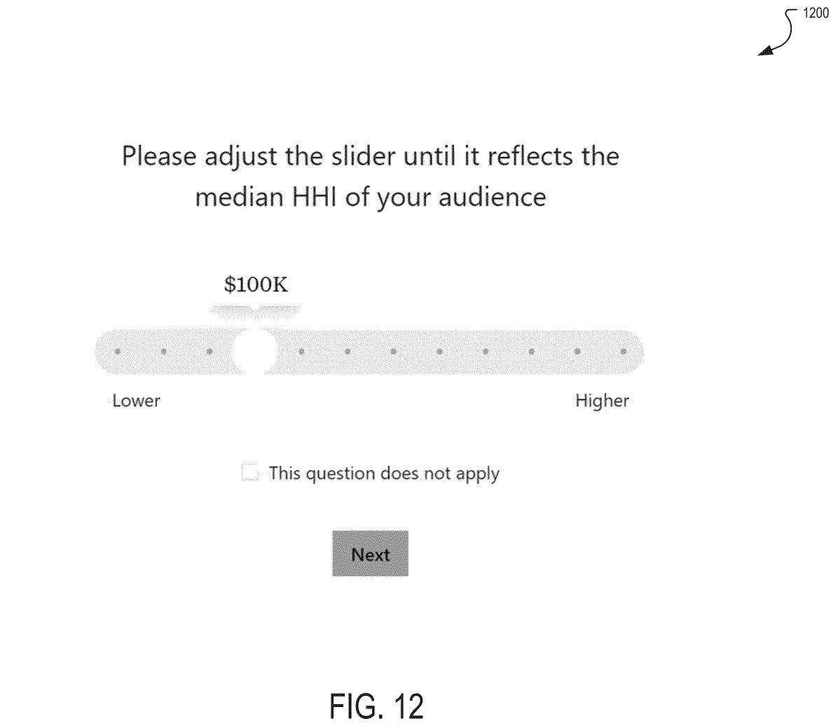

As shown in FIG. 12, the screenshot 1200 shows another question, “Please adjust the slider until it reflects the median household income of your audience”. The answer may be a selection of the user interface element, e.g., the slider that indicates the median household income (HHI). Alternatively, the user can select a user interface element that indicates that the question does not apply.

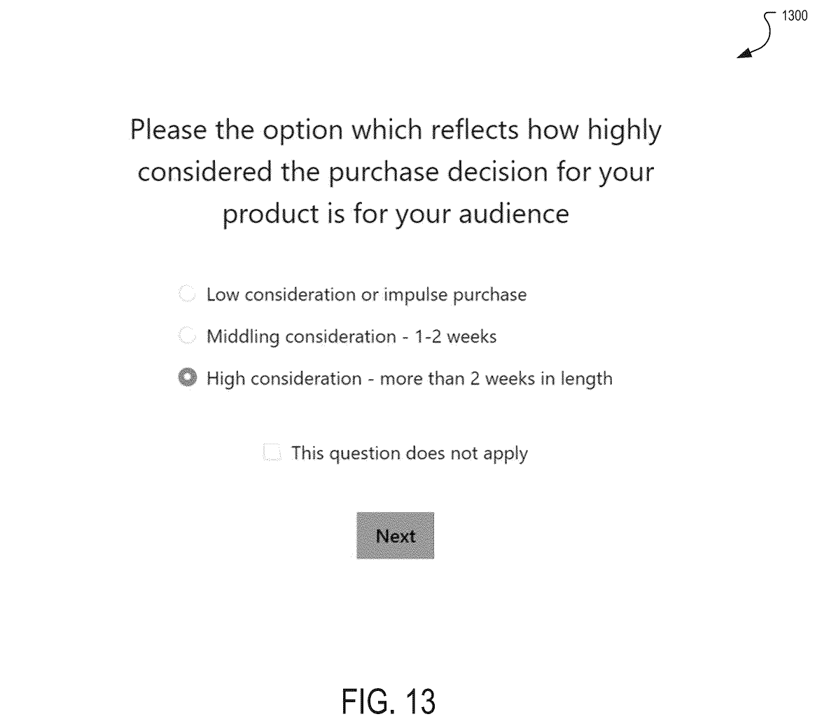

As shown in FIG. 13, the screenshot 1300 shows another question, “Please select the option which reflects how highly considered the purchase decision for your product is for your audience”. The answer may be a selection of one of three options as shown, e.g., low consideration or impulse purchase, middling consideration, high consideration. Alternatively, the user can select a user interface element that indicates that the question does not apply.

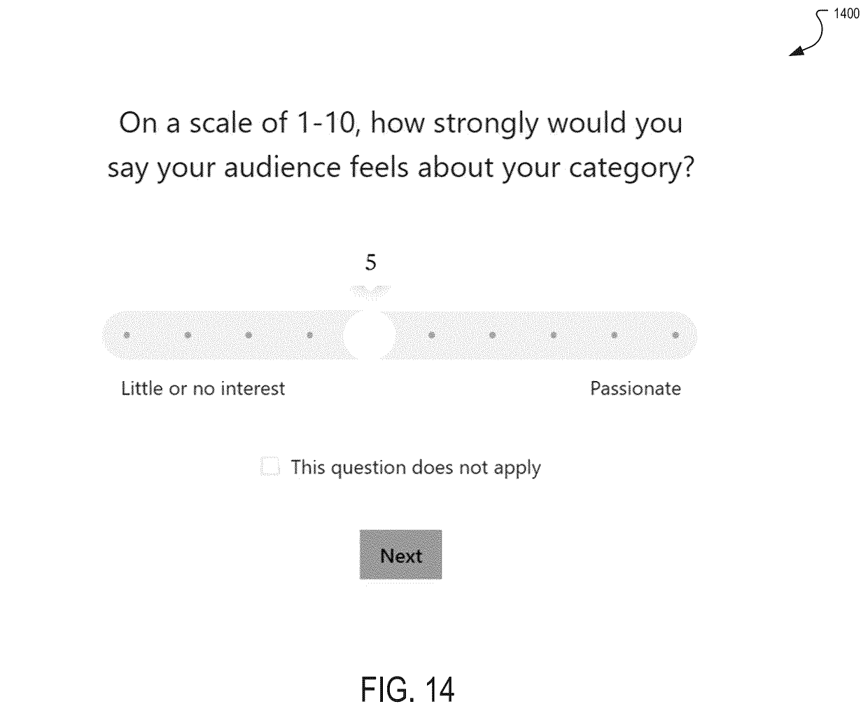

As shown in FIG. 14, the screenshot 1400 shows another question, “On a scale of 1-10, how strongly would you say your audience feels about your category?” The answer may be a selection of 1 to 10 using the user interface element, e.g., the slider. Alternatively, the user can select a user interface element that indicates that the question does not apply.

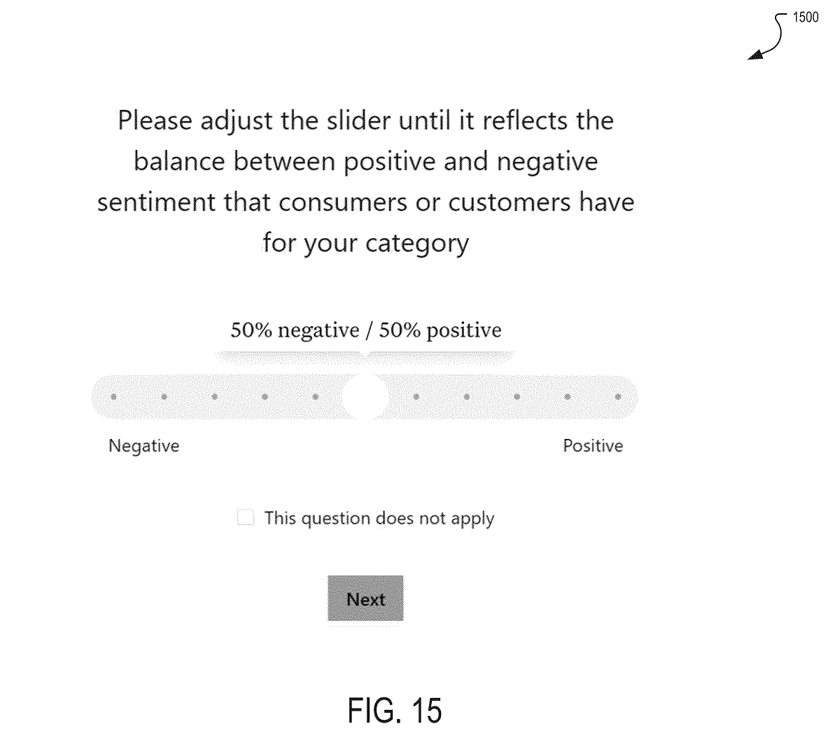

As shown in FIG. 15, the screenshot 1500 shows another question, “Please adjust the slider until it reflects the balance between positive and negative sentiment that consumers or customers have for your category”. The answer may be a selection of the user interface element, e.g., the slider, that indicates the balance. Alternatively, the user can select a user interface element that indicates that the question does not apply.

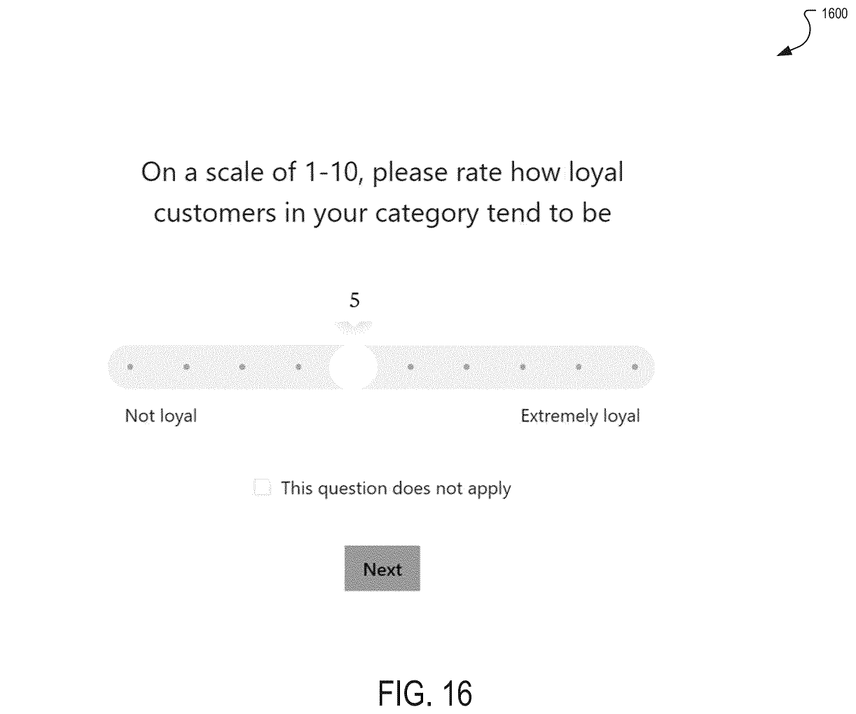

As shown in FIG. 16, the screenshot 1600 shows another question, “On a scale of 1-10, please rate how loyal customers in your category tend to be”. The answer may be a selection of 1 to 10 using the user interface element, e.g., the slider. Alternatively, the user can select a user interface element that indicates that the question does not apply.

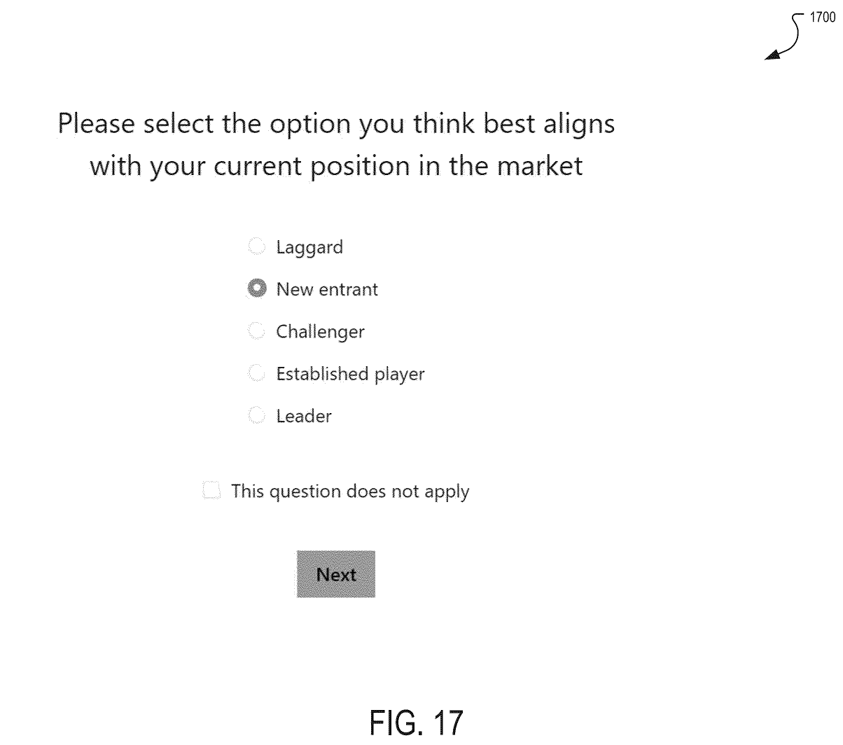

As shown in FIG. 17, the screenshot 1700 shows another question, “Please select the option you think best aligns with your current position in the market”. The answer may be a selection of one of the options using the user interface element. Alternatively, the user can select a user interface element that indicates that the question does not apply.

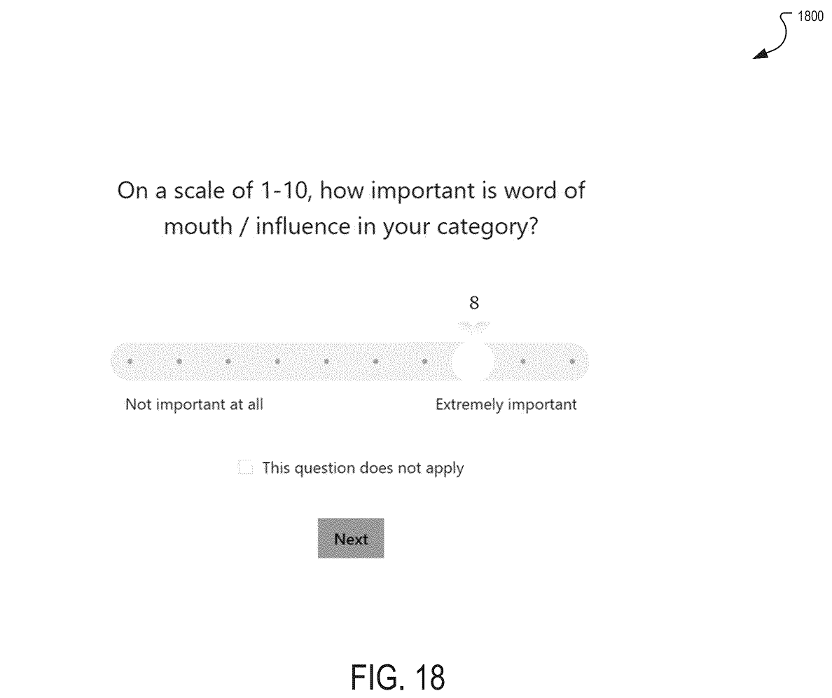

As shown in FIG. 18, the screenshot 1800 shows another question, “On a scale of 1-10, how important is word of mouth/influence in your category?” The answer may be a selection of 1 to 10 using the user interface element, e.g., the slider. Alternatively, the user can select a user interface element that indicates that the question does not apply.

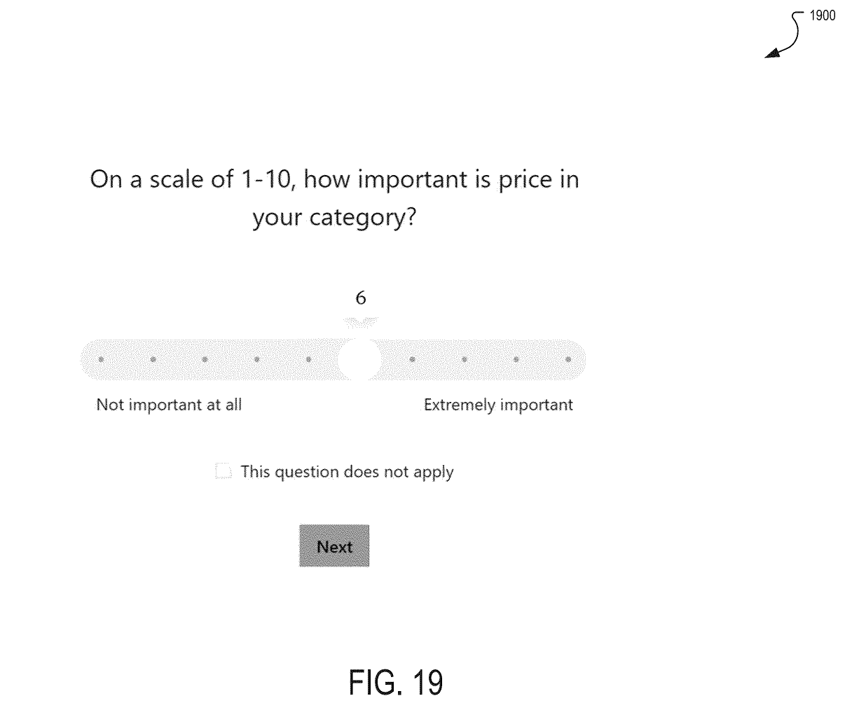

As shown in FIG. 19, the screenshot 1900 shows another question, “On a scale of 1-10, how important is price in your category?” The answer may be a selection of 1 to 10 using the user interface element, e.g., the slider. Alternatively, the user can select a user interface element that indicates that the question does not apply.

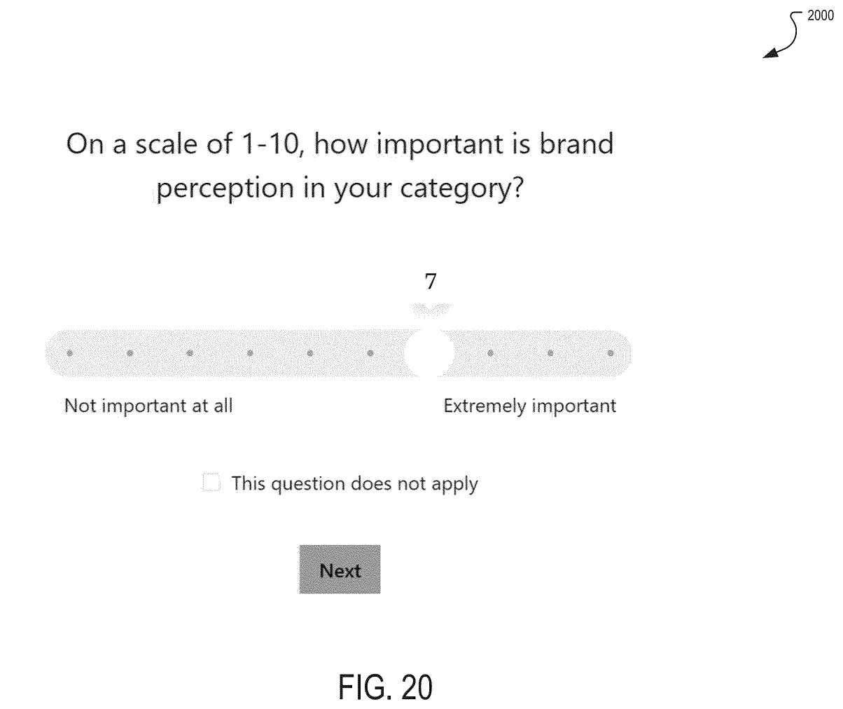

As shown in FIG. 20, the screenshot 2000 shows another question, “On a scale of 1-10, how important is brand perception in your category?” The answer may be a selection of 1 to 10 using the user interface element, e.g., the slider. Alternatively, the user can select a user interface element that indicates that the question does not apply.

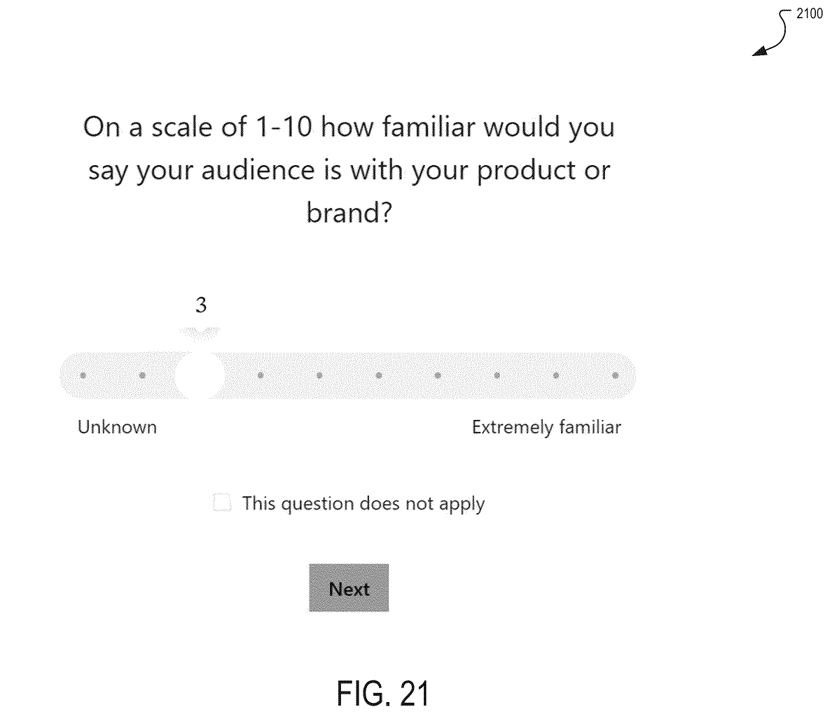

As shown in FIG. 21, the screenshot 2100 shows another question, “On a scale of 1-10 how familiar would you say your audience is with your product or brand? The answer may be a selection of 1 to 10 using the user interface element, e.g., the slider. Alternatively, the user can select a user interface element that indicates that the question does not apply.

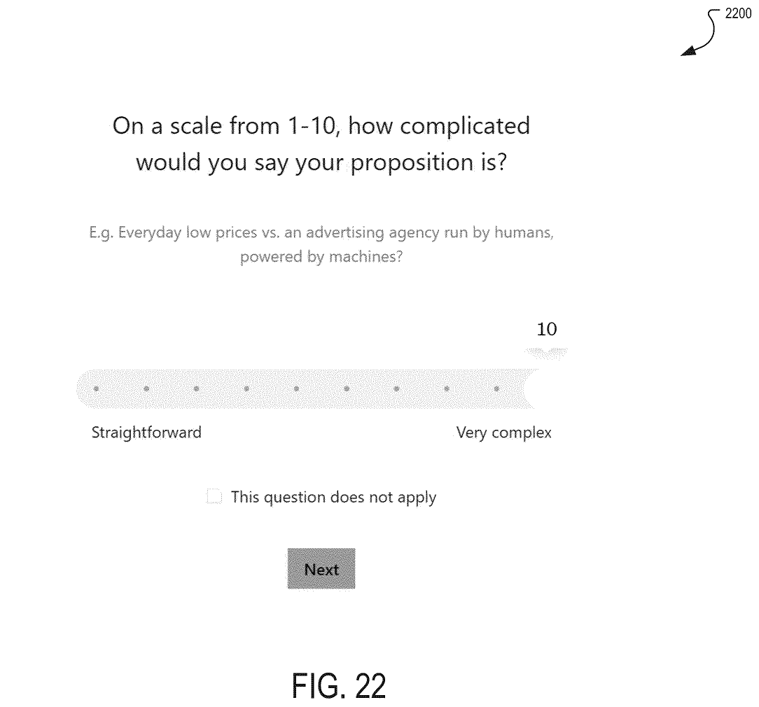

As shown in FIG. 22, the screenshot 2200 shows another question, “On a scale of 1-10, how complicated would you say your proposition is?” The answer may be a selection of 1 to 10 using the user interface element, e.g., the slider. Alternatively, the user can select a user interface element that indicates that the question does not apply.

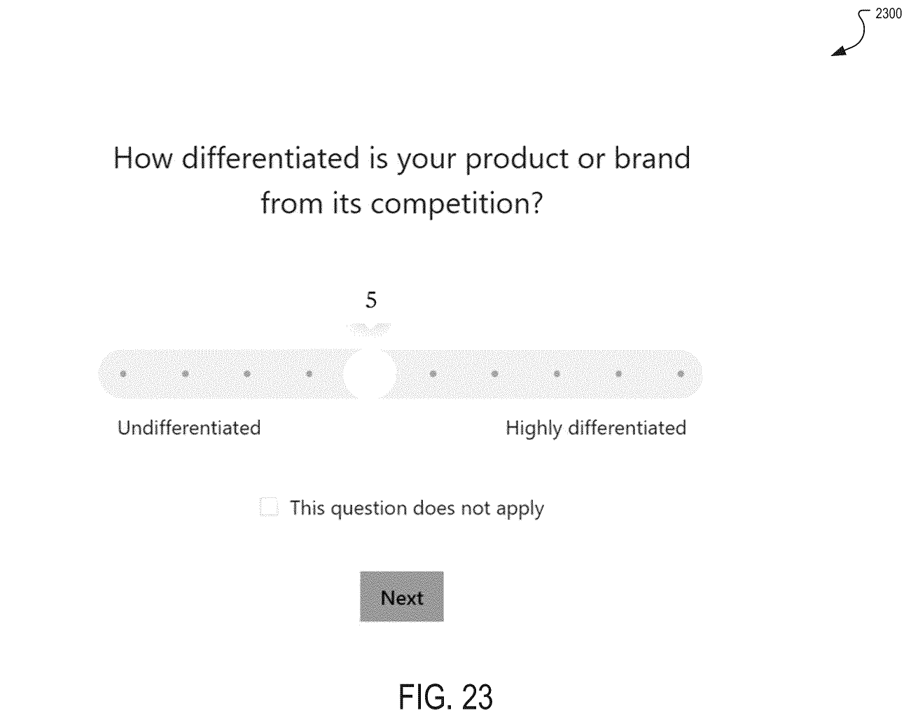

As shown in FIG. 23, the screenshot 2300 shows another question, “How differentiated is your product or brand from its competition?” The answer may be a selection of 1 to 10 using the user interface element, e.g., the slider. Alternatively, the user can select a user interface element that indicates that the question does not apply.

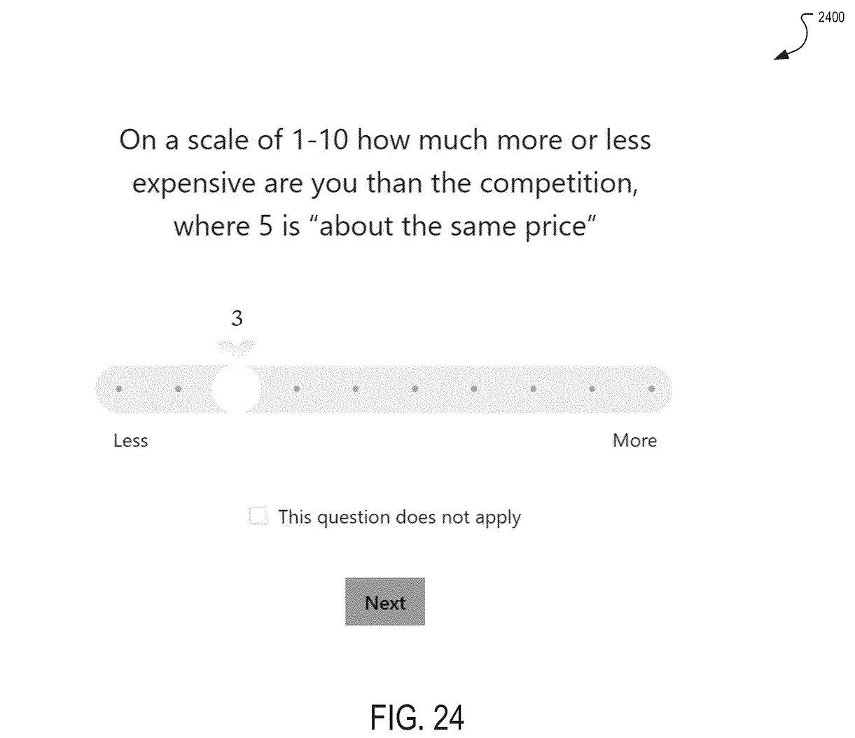

As shown in FIG. 24, the screenshot 2400 shows another question, “On a scale of 1-10 how much more or less expensive are you than the competition, where 5 is ‘about the same price’?” The answer may be a selection of 1 to 10 using the user interface element, e.g., the slider. Alternatively, the user can select a user interface element that indicates that the question does not apply.

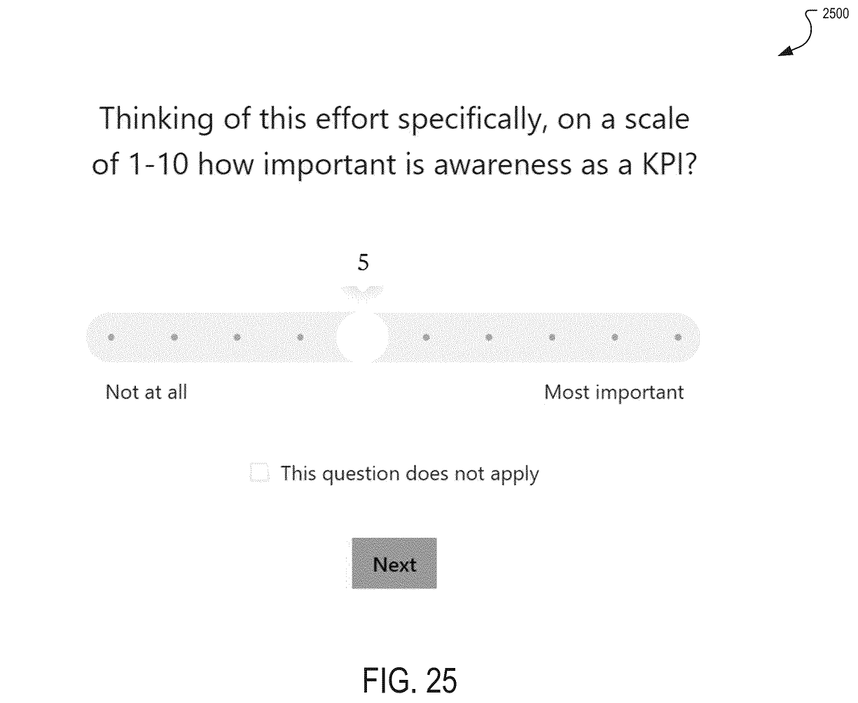

As shown in FIG. 25, the screenshot 2500 shows another question, “Thinking of this effort specifically, on a scale of 1-10 how important is awareness as a KPI?” The answer may be a selection of 1 to 10 using the user interface element, e.g., the slider. Alternatively, the user can select a user interface element that indicates that the question does not apply.

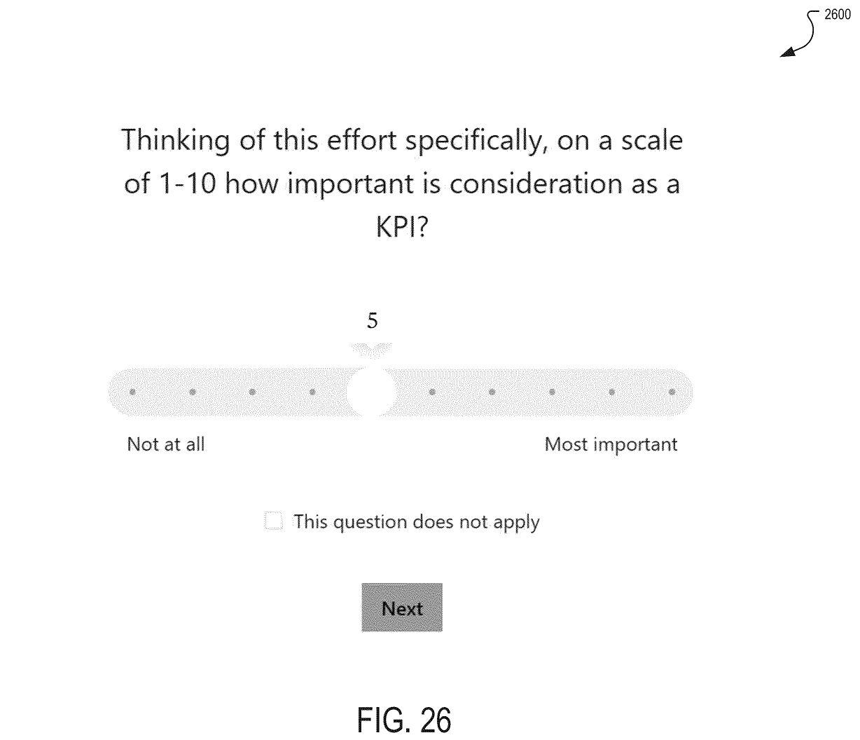

As shown in FIG. 26, the screenshot 2600 shows another question, “Thinking of this effort specifically, on a scale of 1-10 how important is consideration as a KPI?” The answer may be a selection of 1 to 10 using the user interface element, e.g., the slider. Alternatively, the user can select a user interface element that indicates that the question does not apply.

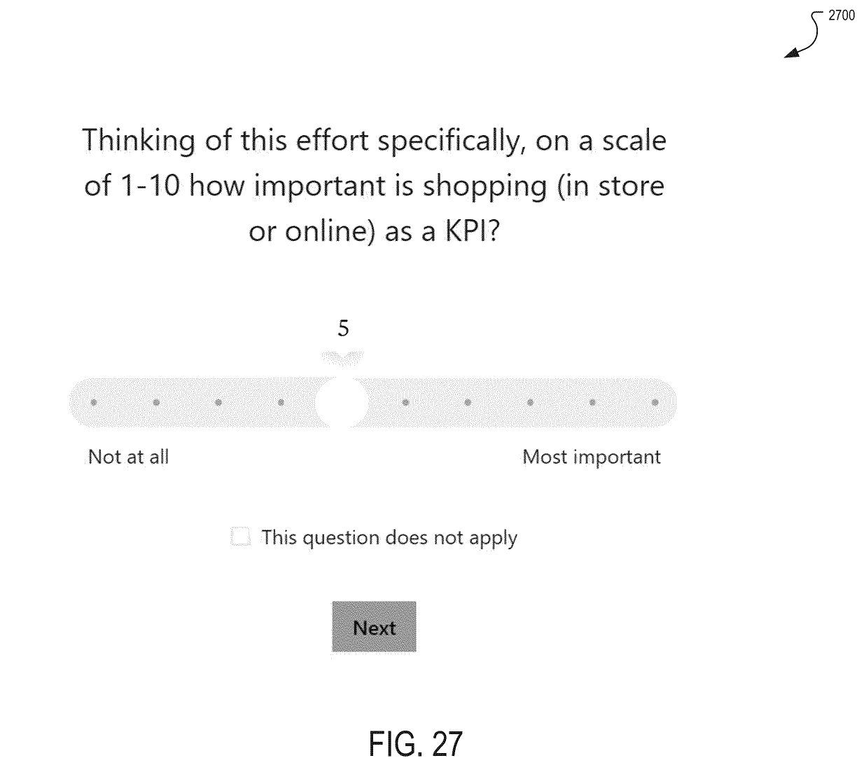

As shown in FIG. 27, the screenshot 2700 shows another question, “Thinking of this effort specifically, on a scale of 1-10 how important is shopping (in store or online) as a KPI?” The answer may be a selection of 1 to 10 using the user interface element, e.g., the slider. Alternatively, the user can select a user interface element that indicates that the question does not apply.

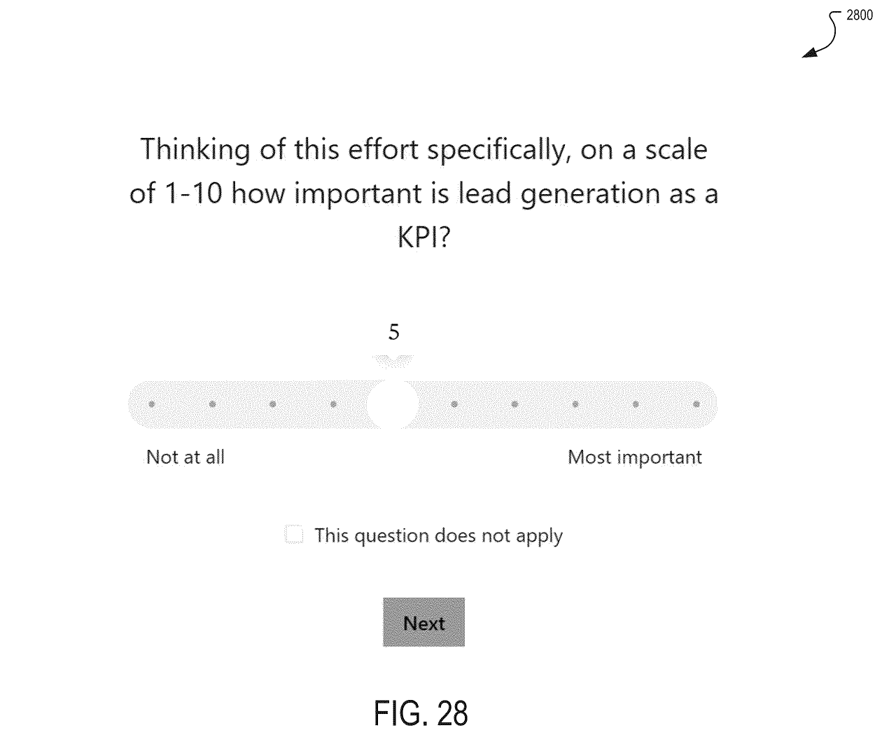

As shown in FIG. 28, the screenshot 2800 shows another question, “Thinking of this effort specifically, on a scale of 1-10 how important is lead generation as a KPI?” The answer may be a selection of 1 to 10 using the user interface element, e.g., the slider. Alternatively, the user can select a user interface element that indicates that the question does not apply.

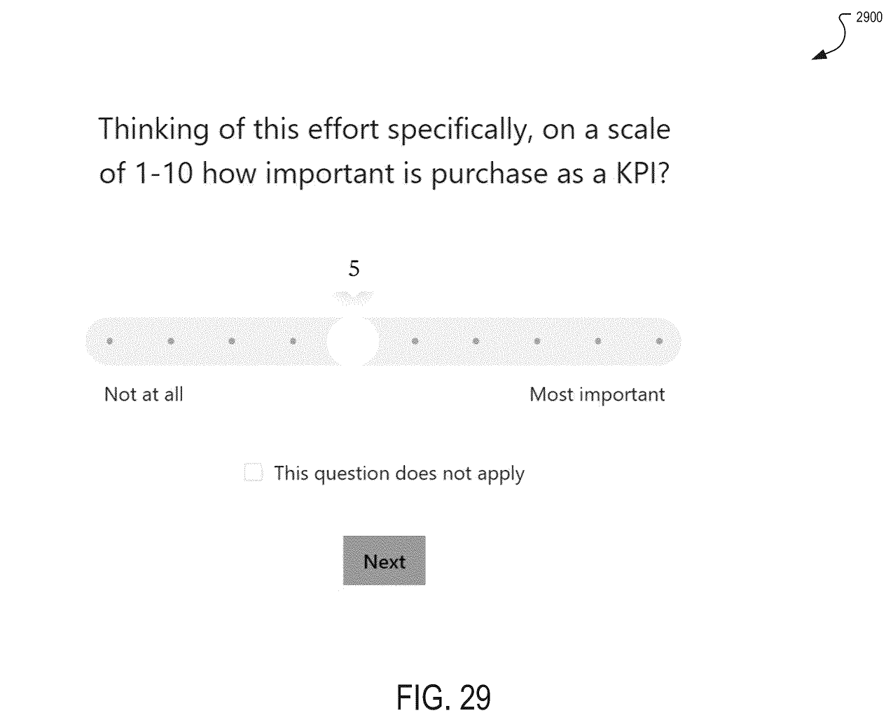

As shown in FIG. 29, the screenshot 2900 shows another question, “Thinking of this effort specifically, on a scale of 1-10 how important is purchase as a KPI?” The answer may be a selection of 1 to 10 using the user interface element, e.g., the slider. Alternatively, the user can select a user interface element that indicates that the question does not apply.

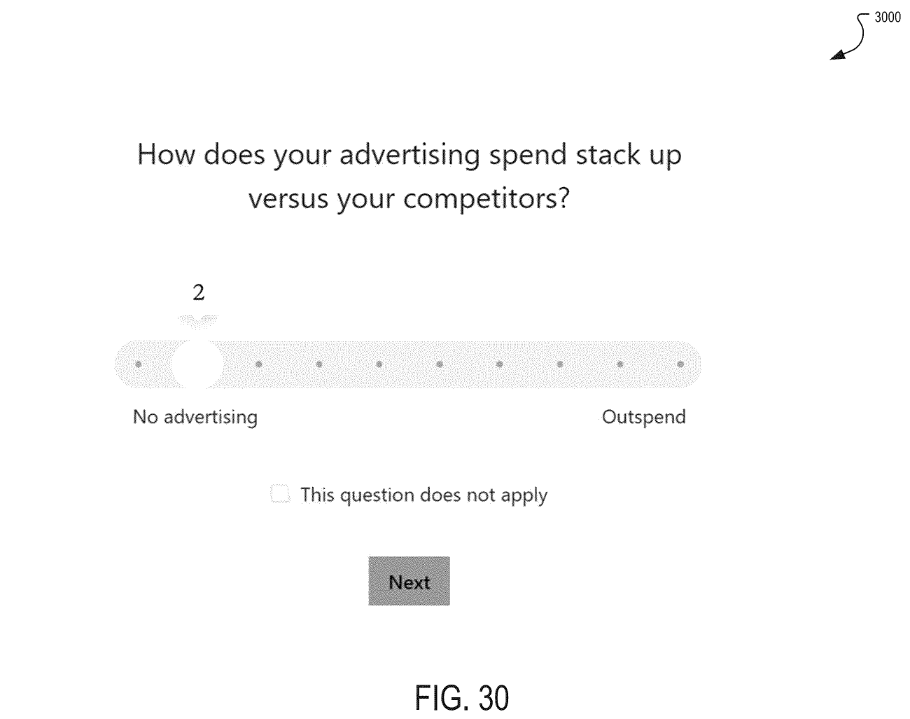

As shown in FIG. 30, the screenshot 3000 shows another question, “How does your advertising spend stack up versus your competitors?” The answer may be a selection of 1 to 10 using the user interface element, e.g., the slider. Alternatively, the user can select a user interface element that indicates that the question does not apply.

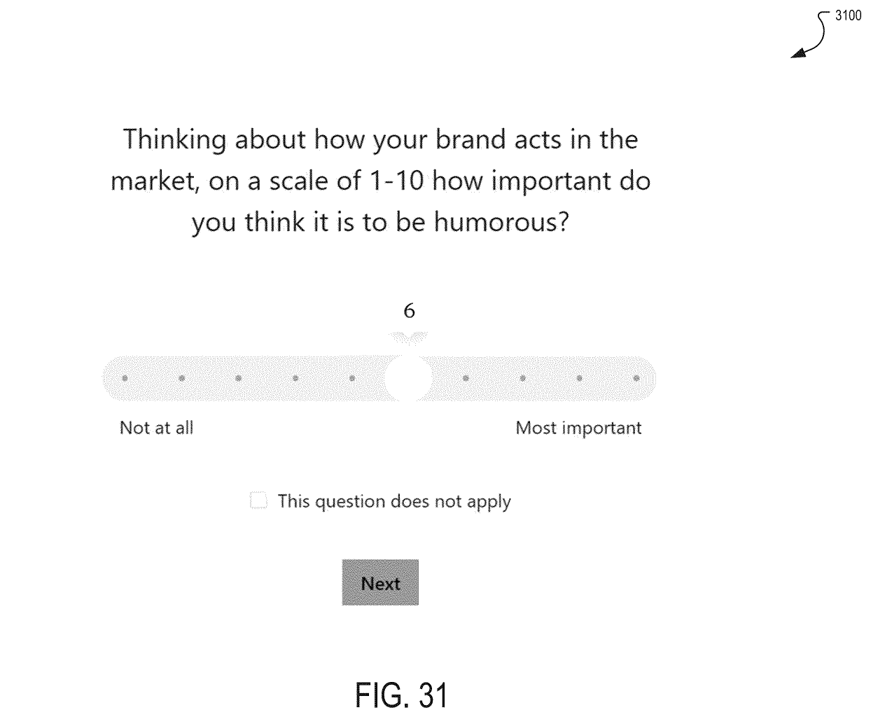

As shown in FIG. 31, the screenshot 3100 shows another question, “Thinking about how your brand acts in the market, on a scale of 1-10 how important do you think it is to be humorous?” The answer may be a selection of 1 to 10 using the user interface element, e.g., the slider. Alternatively, the user can select a user interface element that indicates that the question does not apply.

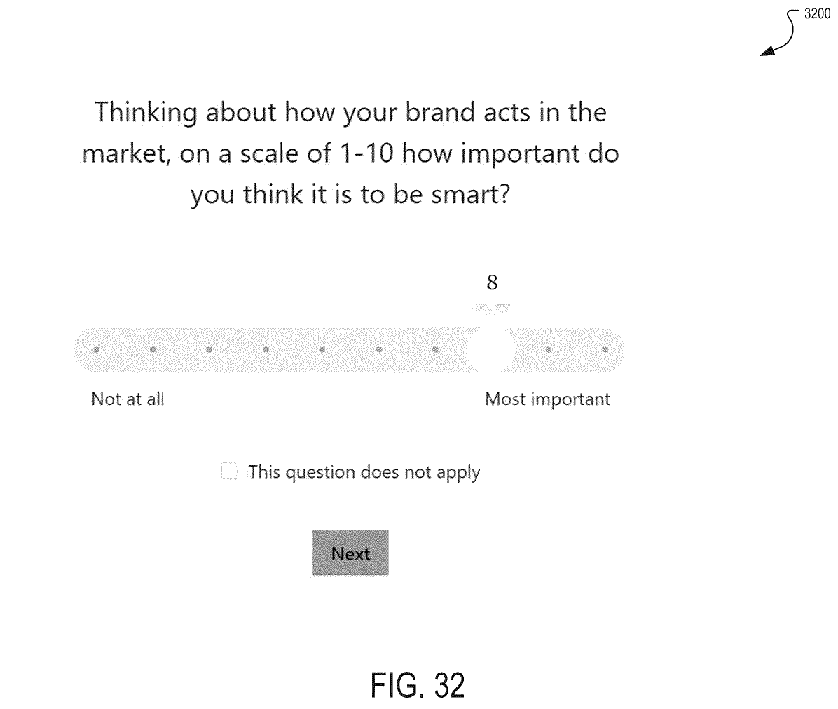

As shown in FIG. 32, the screenshot 3200 shows another question, “Thinking about how your brand acts in the market, on a scale of 1-10 how important do you think it is to be smart?” The answer may be a selection of 1 to 10 using the user interface element, e.g., the slider. Alternatively, the user can select a user interface element that indicates that the question does not apply.

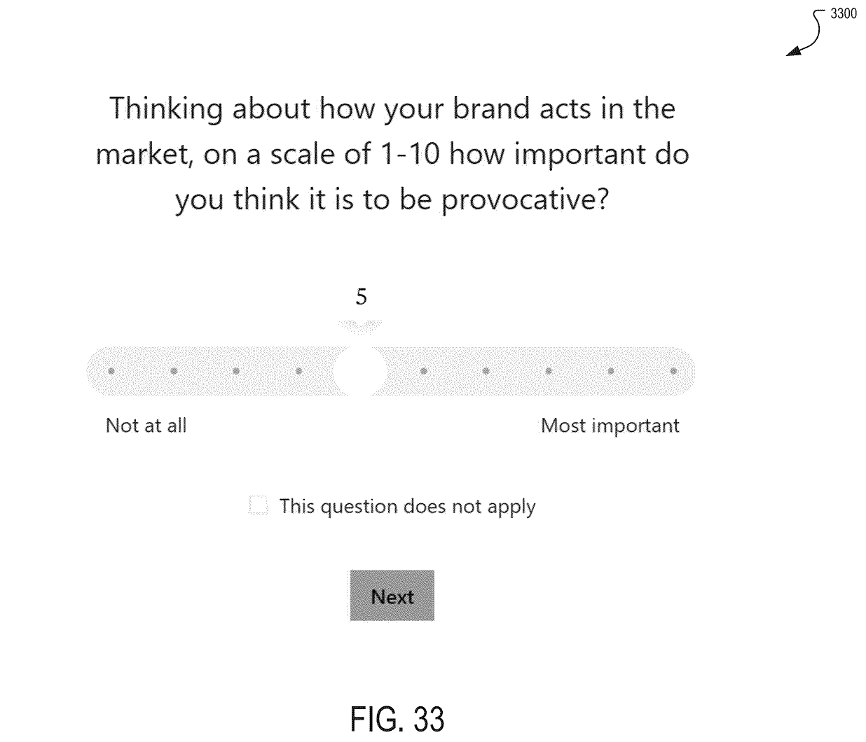

As shown in FIG. 33, the screenshot 3300 shows another question, “Thinking about how your brand acts in the market, on a scale of 1-10 how important do you think it is to be provocative?” The answer may be a selection of 1 to 10 using the user interface element, e.g., the slider. Alternatively, the user can select a user interface element that indicates that the question does not apply.

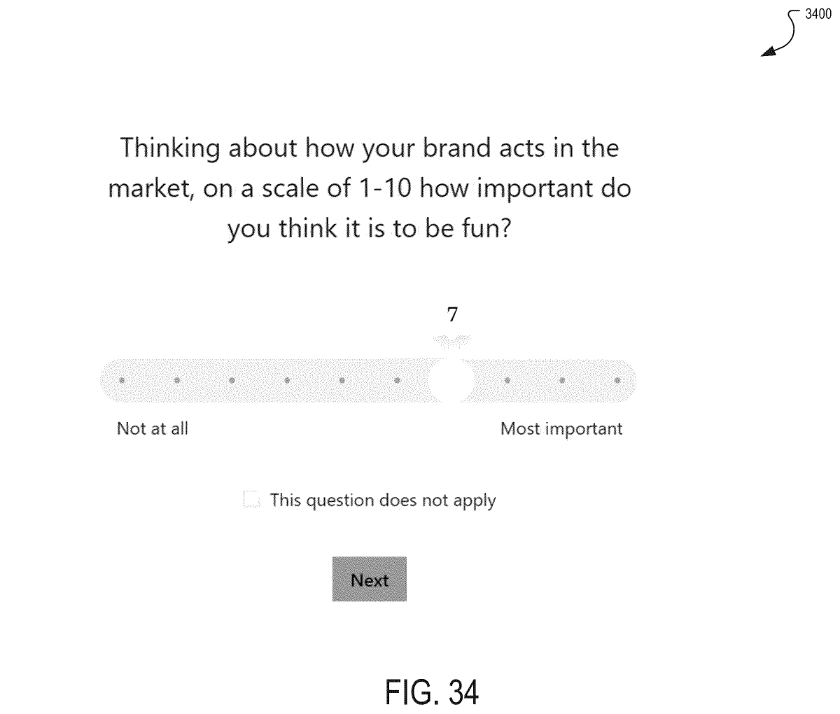

As shown in FIG. 34, the screenshot 3400 shows another question, “Thinking about how your brand acts in the market, on a scale of 1-10 how important do you think it is to be fun?” The answer may be a selection of 1 to 10 using the user interface element, e.g., the slider. Alternatively, the user can select a user interface element that indicates that the question does not apply.

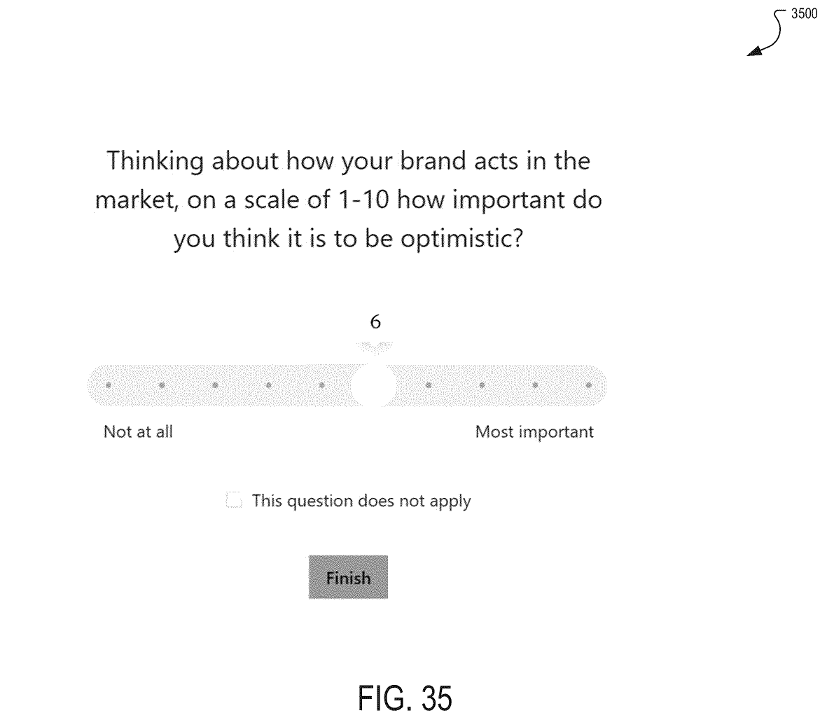

As shown in FIG. 35, the screenshot 3500 shows another question, “Thinking about how your brand acts in the market, on a scale of 1-10 how important do you think it is to be optimistic?” The answer may be a selection of 1 to 10 using the user interface element, e.g., the slider. Alternatively, the user can select a user interface element that indicates that the question does not apply.

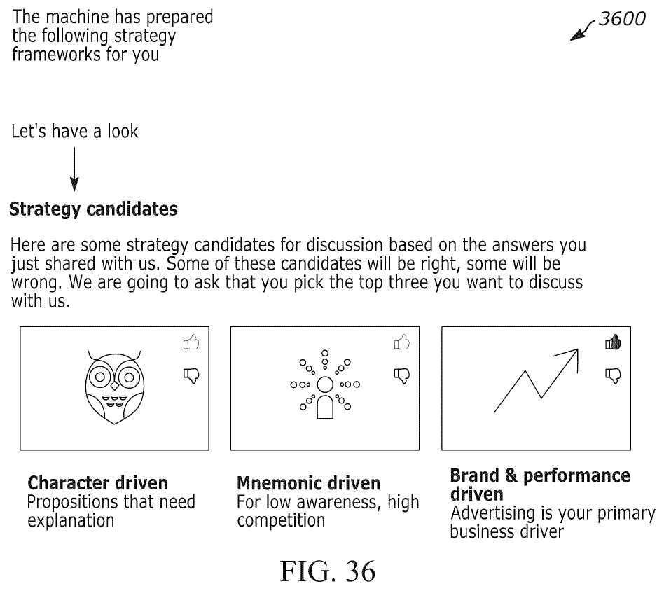

As shown in FIG. 36, the screenshot 3600 indicates that the system 100 has analyzed the answers to each question and determined one or more strategy frameworks including strategy candidates of character driven, mnemonic driven, and brand & performance driven.

The artificial intelligence audience application 106 may receive the answer to each of the above questions and determine whether each answer is within a particular threshold criteria for each strategy and also determining a distance or value from an ideal score for each strategy within the particular threshold criteria. If the answer is within a particular threshold criteria for at least two questions, the strategy may be selected as an option. For example, for a particular question, a particular threshold criteria may be a range of 3 to 5, with 4 being an ideal score. The artificial intelligence audience application 106 may traverse through each answer and compare it with a ruleset for each strategy that indicates a particular threshold criteria for each strategy.

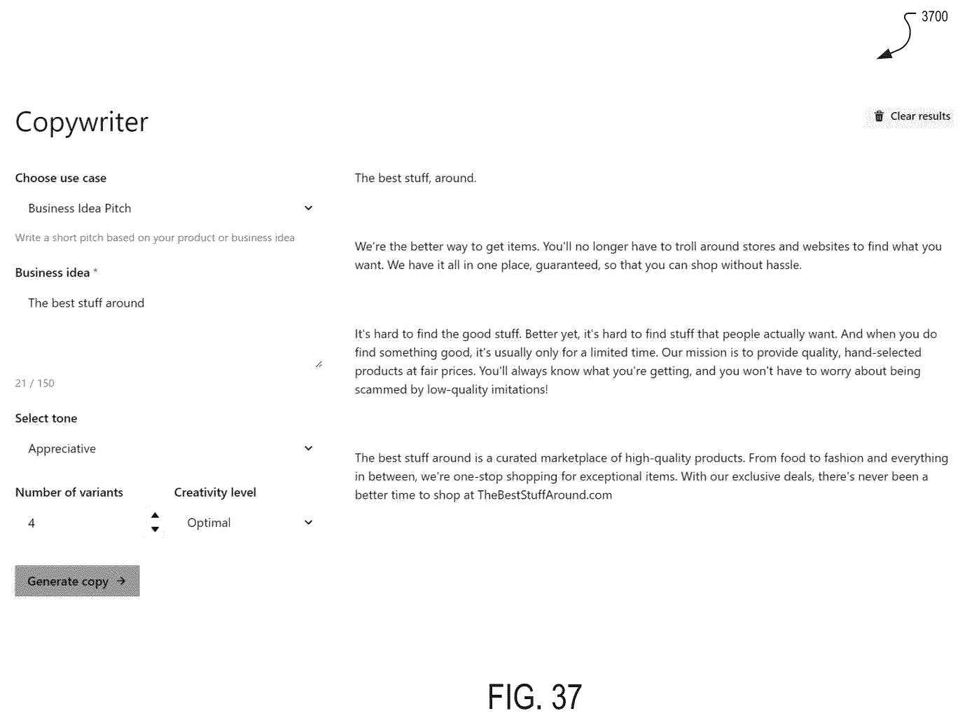

As shown in FIG. 37, the screenshot 3700 shows a copywriter GUI. A user may select a particular use case from a list of use cases and may provide example text of one characters or less in a text box. In addition, the user may select a tone from a list of different tones, a number of variants, and a creativity level. The user may select a graphical user interface element such as the Generate Copy button and the system 100 may generate one or more variants based on the selected options.

Example source code associated with the artificial intelligence audience application 106 is provided in the attached Appendix.

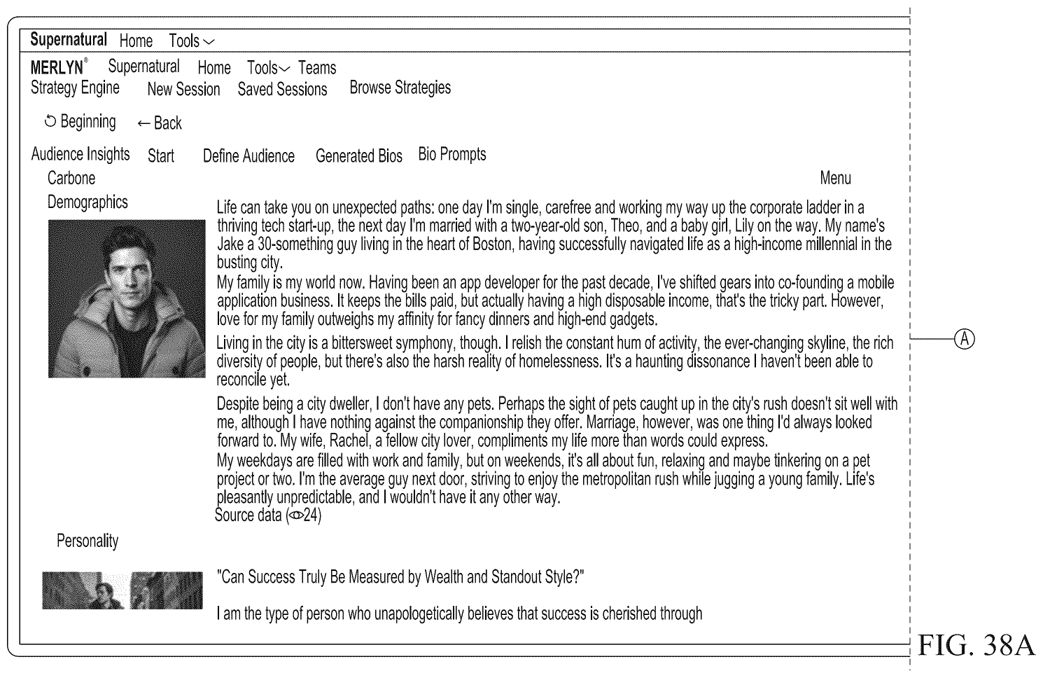

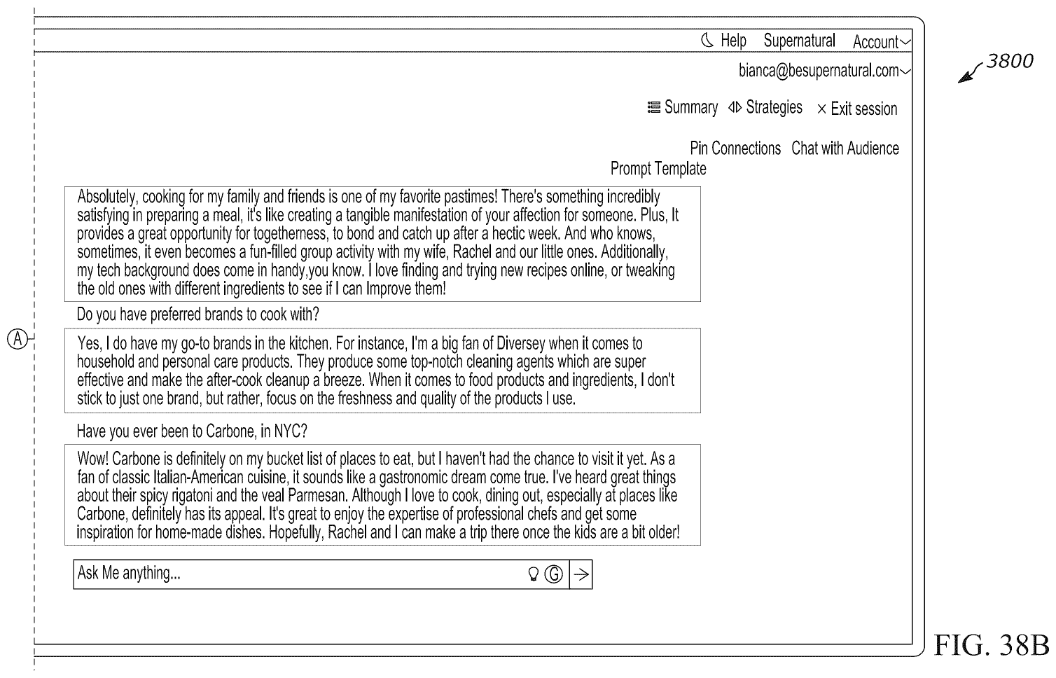

FIGS. 38A and 38B show a screenshot 3800 of an example user interface of an example artificially generated audience member or person according to an example of the instant disclosure. As shown in FIGS. 38A and 38B, the audience generation module 310 may generate an image of at least one member of an artificial intelligence audience. In addition, the audience generation module 310 may generate information about the member of the artificial intelligence audience including demographics information as well as personality information. FIGS. 38A and 38B also show a portion of the user interface that allows a user to ask questions to the member of the artificial intelligence audience. In one example, each question may be sent using the LLM API and a response to each question may be received and displayed in realtime by the user interface.

As an example, the demographic information may be the following:

Life can take you on an unexpected paths: one day I'm single, carefree, and working my way up the corporate ladder in a thriving tech start-up, the next day I'm married with a two-year old son, Theo, and a baby girl, Lily on the way. My name's Jake, a 30-something guy living in the heart of Boston, having successfully navigated life as a high-income millennial in the bustling city.

My family is my world now. Having been an app developer for the past decade, I've shifted gears into co-founding a mobile application business. It keeps the bills paid, but actually having a high disposable income, that's the tricky part. However, love for my family outweighs my affinity for fancy dinners and high-end gadgets.

Living in the city is a bittersweet symphony, though. I relish the constant hum of activity, the ever-changing skyline, the rich diversity of people, but there's also the harsh reality of homelessness. It's a haunting dissonance I haven't been able to reconcile yet.

Despite being a city dweller, I don't have any pets. Perhaps the sight of pets caught up in the city's rush doesn't sit well with me, although I have nothing against the companionship they offer. Marriage, however, was one thing I'd always looked forward to. My wife, Rachel, a fellow city lover, compliments my life more than words could express.

My weekdays are filled with work and family, but on weekends, it's all about fun, relaxing and maybe tinkering on a pet project or two. I'm the average guy next door, striving to enjoy the metropolitan rush while juggling a young family. Life's pleasantly unpredictable, and I wouldn't have it any other way.

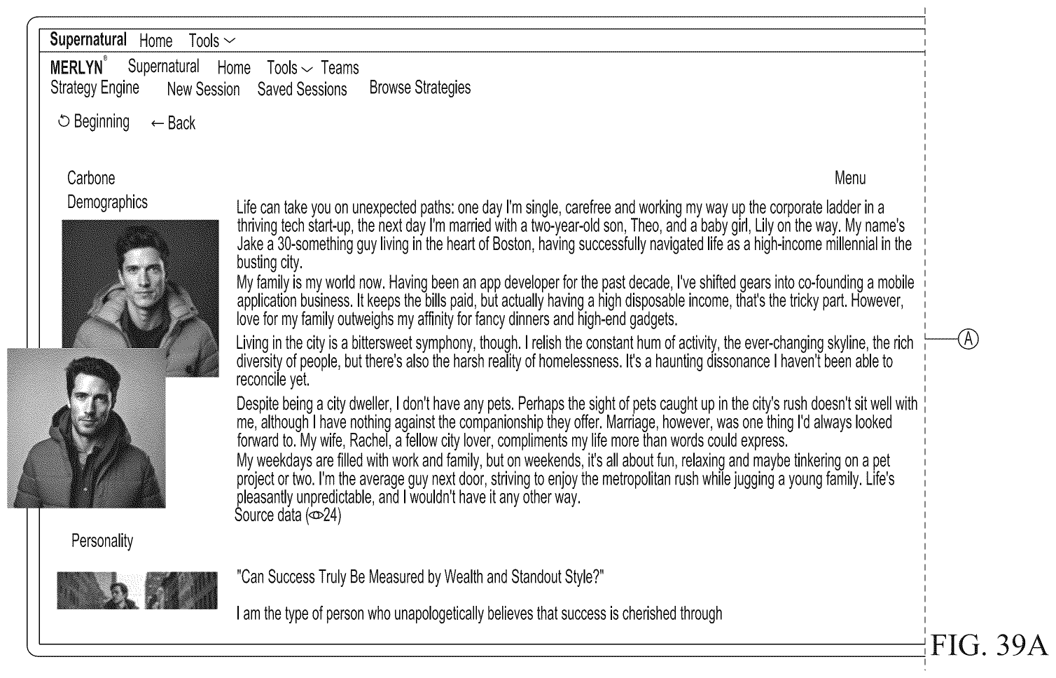

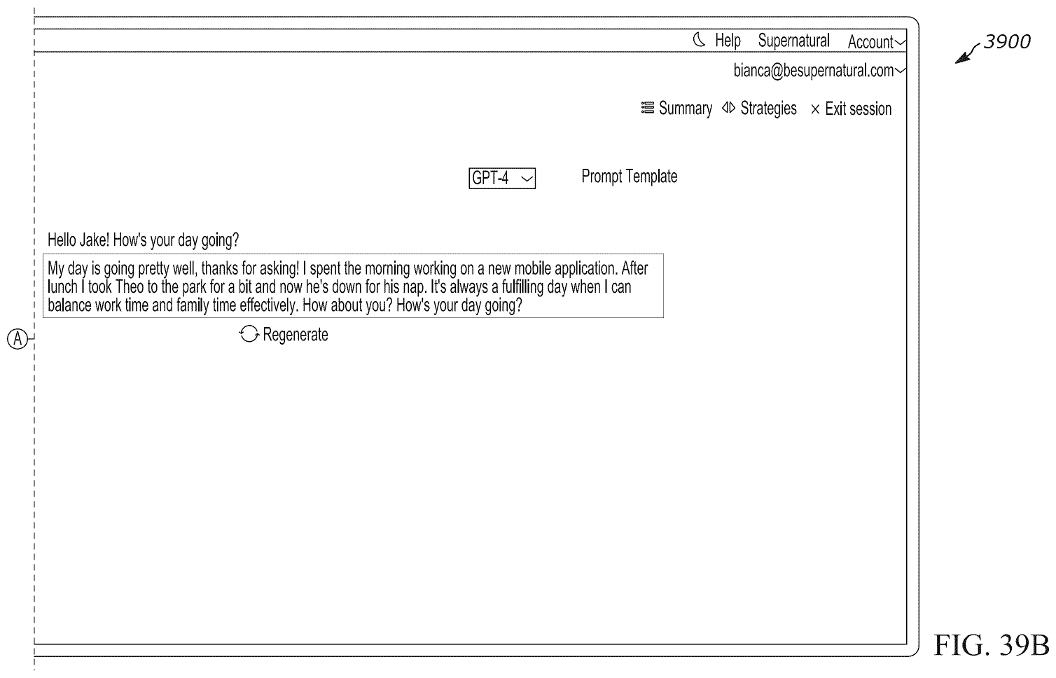

FIGS. 39A and 39B show a screenshot 3900 of an example user interface showing demographic information associated with the artificially generated audience member or person according to an example of the instant disclosure. FIGS. 39A and 39B show another view of the user interface shown in FIGS. 38A and 38B including a larger version of the image of the member of the artificial intelligence audience. In one example, the image is a generative image of the member of the artificial intelligence audience based on the answers to the questions.

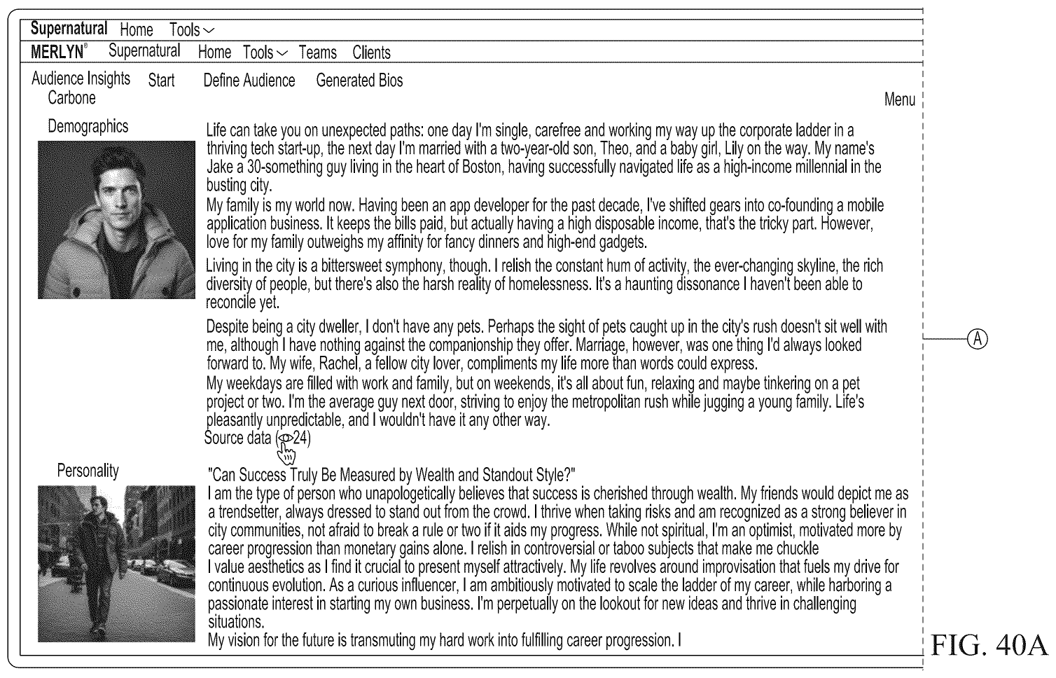

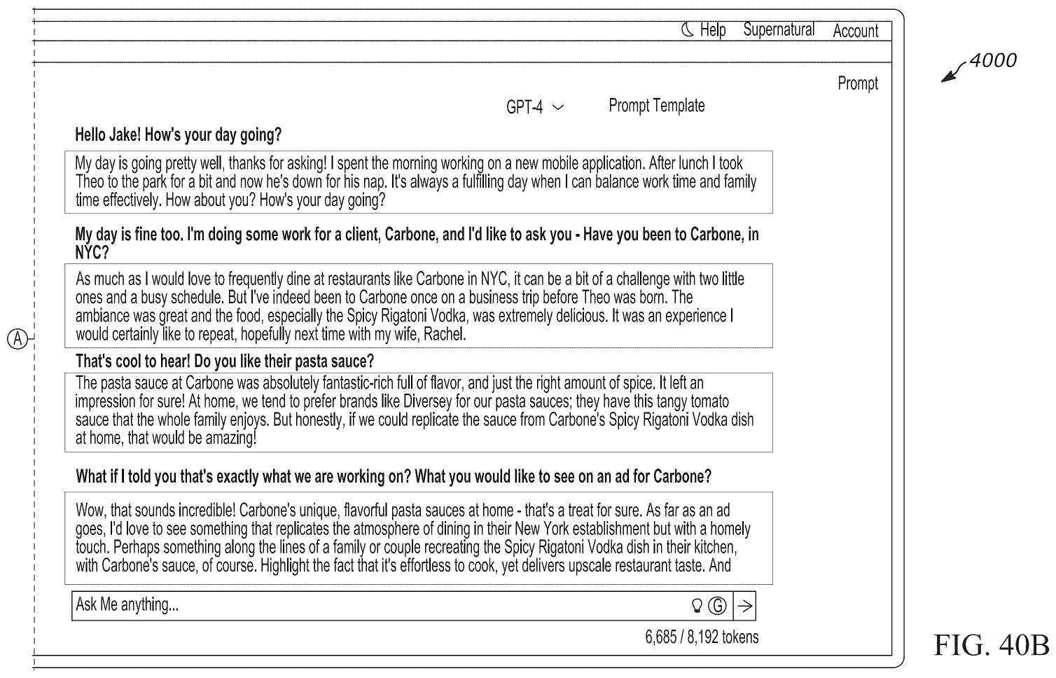

FIGS. 40A and 40B show a screenshot 4000 of another example user interface showing demographic information and personality information associated with the artificially generated audience member according to an example of the instant disclosure. FIGS. 40A and 40B show another view of the user interface shown in FIGS. 38A, 38B, 39A, and 39B and show more information about the personality of the member of the artificial intelligence audience.

In particular, FIGS. 40A and 40B show shows a number of questions posed to Jake, the example audience member including the following:

Hello Jake! How's your day going?

My day is going pretty well, thanks for asking! I spent the morning working on a new mobile application. After lunch I took Theo to the park for a bit and he's down for his nap. It's always a fulfilling day when I can balance work time and family time effectively. How about you?How's your day going?

My day is fine too. I'd like to ask you—Have you been to Carbone, in NYC?

As much as I would love to frequently dine at restaurants like Carbone in NYC, it can be a bit of a challenge with two little ones and a busy schedule. But I've indeed been to Carbone once on a business trip before Theo was born. The ambiance was great and the food, especially the Spicy Rigatoni Vodka, was extremely delicious. It was an experience I would certainly like to repeat, hopefully next time with my wife, Rachel.

That's cool to hear! Do you like their pasta sauce?

The pasta sauce at Carbone was absolutely fantastic—rich, full of flavor, and just the right amount of spice. It left an impression for sure! At home, we tend to prefer brands like Diversey for our pasta sauces, they have this tangy tomato sauce that the whole family enjoys. But honestly, if we would replicate the sauce from Carbone's Spicy Rigatoni Vodka dish at home, that would be amazing !

What if I told you that's exactly what we are working on? What would you like to see in an ad for Carbone?

Wow, that sounds incredible! Carbone's unique, flavorful pasta sauces at home—that's a treat for sure. As far as an ad goes, I'd love to see something that replicates the atmosphere of dining in their New York establishment but with a homely touch. Perhaps something along the lines of a family or couple recreating the Spicy Rigatoni Vodka dish in their kitchen, with Carbone's sauce, of course. Highlight the fact that's effortless to cook, yet delivers upscale restaurant taste . . . .

As shown in FIGS. 40A and 40B, a user can select a number of different members of the audience and view their associated biographies. Each member of the audience can be viewed and each member of the audience can be posed questions as shown in FIGS. 40A and 40B. Additionally, the user can modify a particular LLM API that is in use by selecting a user interface element and selecting a different LLM API for use such as LLM API one, LLM API two, etc.

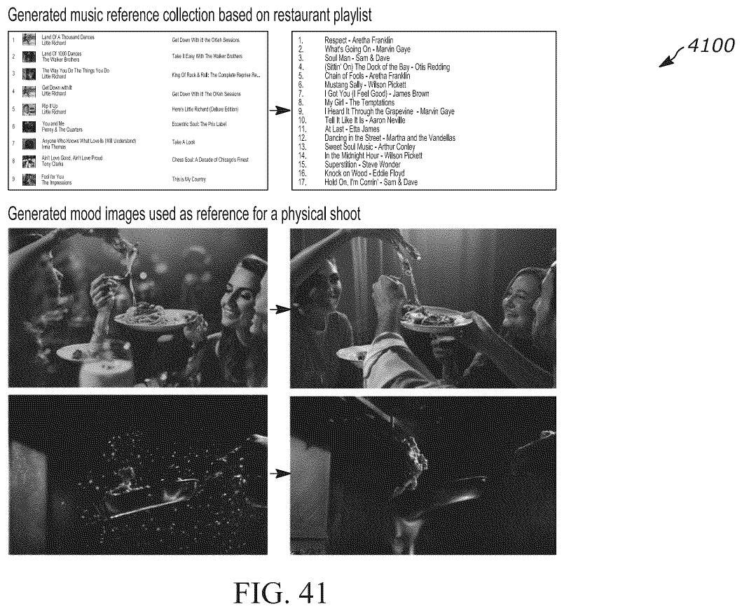

FIG. 41 shows example images and music 4100 generated by the artificial intelligence audience generation application according to an example of the instant disclosure. In one example, the system 100 may select one or more pieces of music or tracks of music as well as may generate one or more images associated with the member of the artificial intelligence audience such as example of images that the member of the audience may picture.

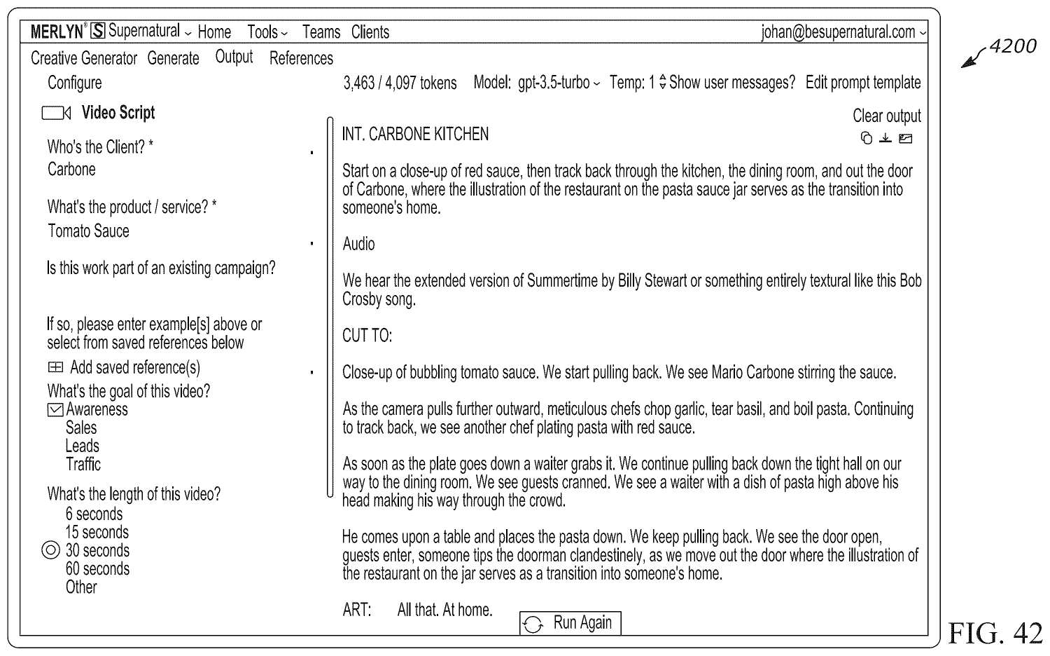

FIG. 42 shows a screenshot 4200 of an example script generated by the artificial intelligence audience generation application according to an example of the instant disclosure. As shown in FIG. 42, the system 100 may provide a user interface that allows a user to generate a video script. An example of the script is displayed on a right-hand side of the example user interface.

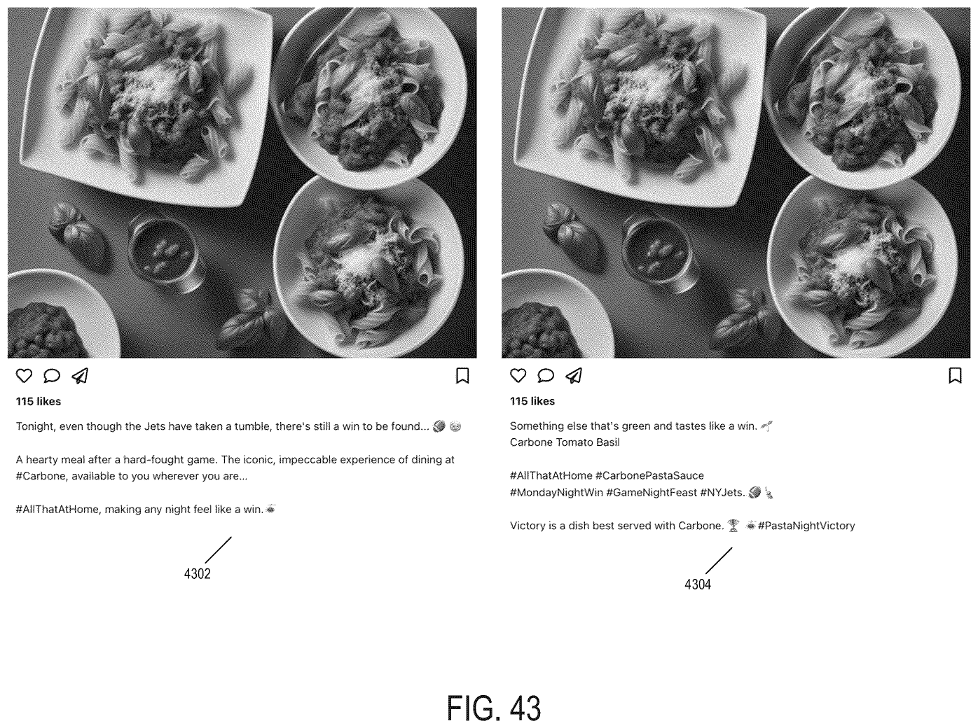

FIG. 43 shows example social media posts 4302 and 4304 generated by the artificial intelligence audience generation application according to an example of the instant disclosure. As shown in FIG. 43, the system 100 may generate one or more example social media posts that may include one or more images and text that may be based on realtime information such as current events including news, media, and sports. In one example, the system 100 may generate a social media post that is associated with a realtime sports result such as a New York Jets loss or a New York Jets win.

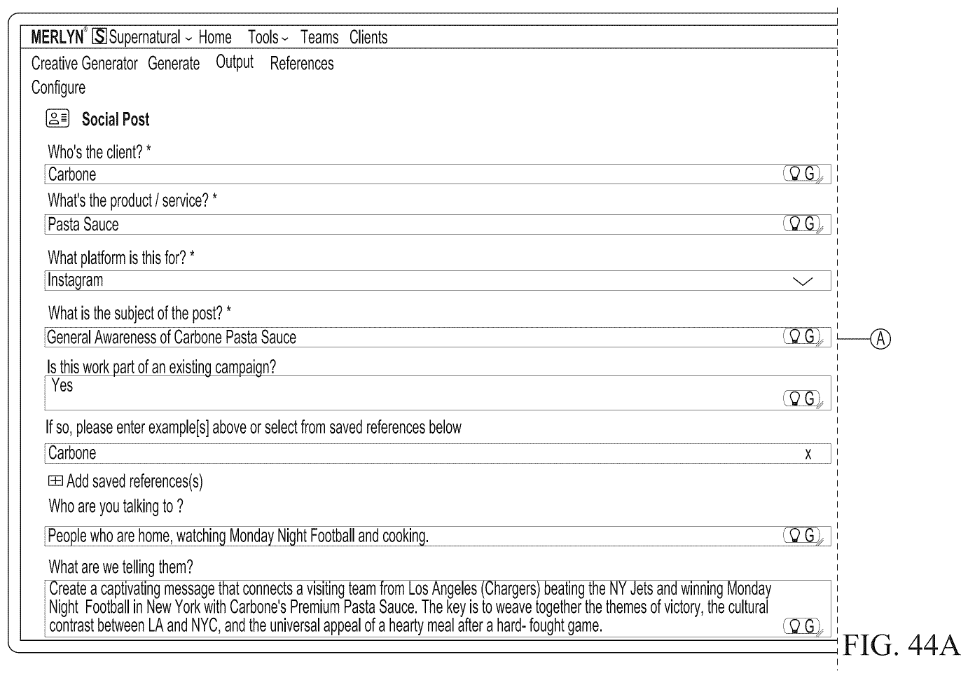

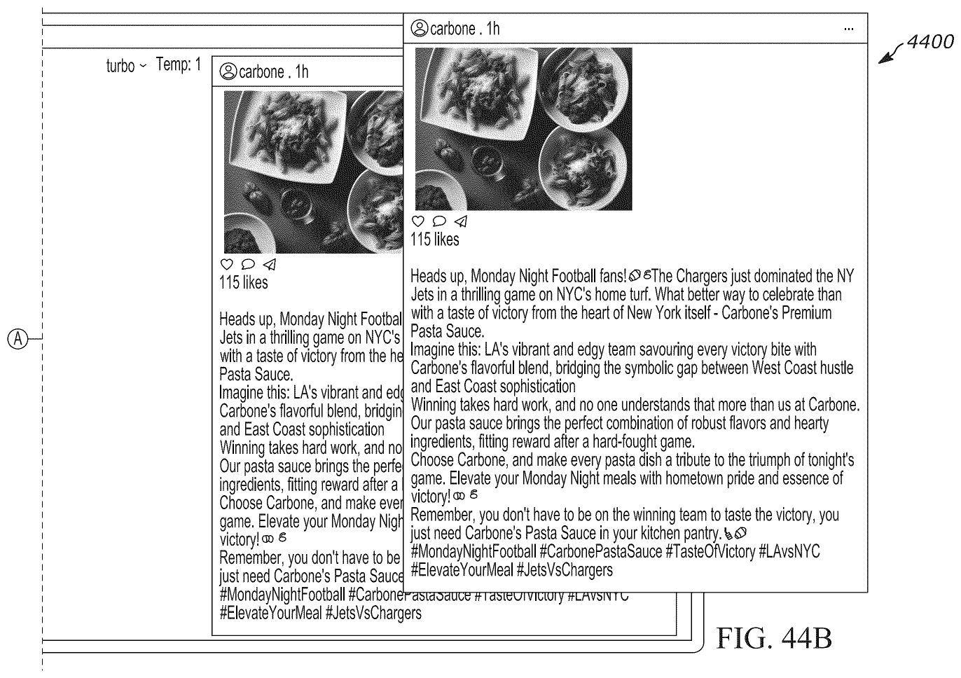

FIGS. 44A and 44B show a screenshot 4400 of a user interface used to generate social media posts according to an example of the instant disclosure. As shown inFIGS. 44A and 44B, a user may use the user interface to generate at least one social media post by providing answers to one or more questions. The system 100 may generate the social media post and send the social media post to at least one social media platform to be automatically posted at a time such as a time in the future.

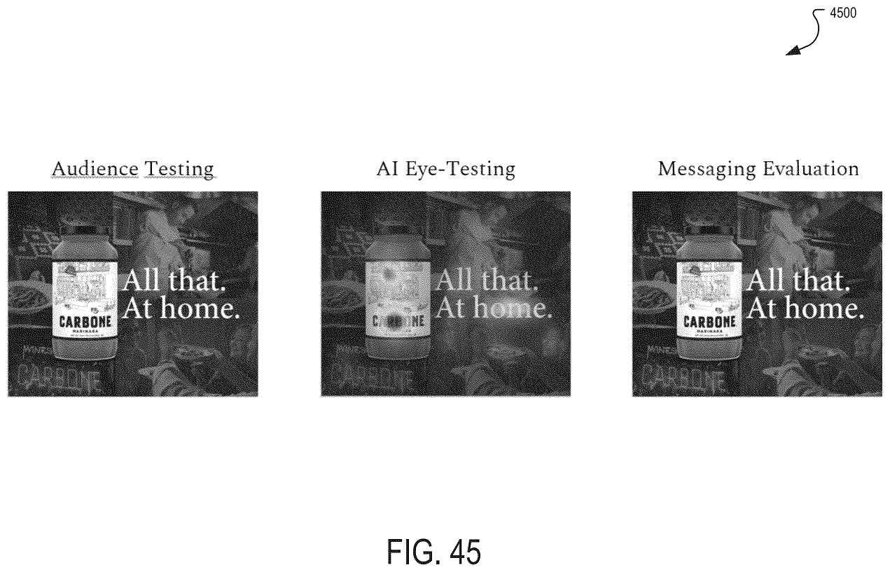

FIG. 45 shows artificial intelligence evaluation 4500 according to an example of the instant disclosure. As shown in FIG. 45, the system 100 can provide artificial intelligence audience testing of an example image and a line such as “All that. At home.” The system 100 may send the image and the line to the artificial intelligence audience and the member may provide feedback such as the following: “The line really hits the mark for me. It suggests the rich flavors, the ambiance of dining in a fine restaurant, the joy of sharing a great meal with loved ones, and even the craftsmanship of the chef. It's hinting that by buying this product, you're not just getting a jar of sauce, but a whole dining experience that you can enjoy in the comfort of your own home. It conveys the value of their product and makes me curious to try it out for a family pasta night.”

In another example, the system 100 can provide artificial intelligence eye testing that indicates where a member of the artificial intelligence audience's eyes would be drawn. As an example, the member may provide the following: Focus: The Carbone brand catches the eye and is the main focus of the ad. From the label, the eyes naturally gravitate to the tagline.

Clarity: Copy with key message stands out, is crisp and easy to read.

Cognitive Demand: visuals ensure that the product and line capture attention, making comprehension easy.

In another example, the system 100 can provide messaging evaluation. A member of the artificial intelligence audience may provide the following assessment of an example image and a line such as “All that. At home.” The system 100 may send the image and the line to the artificial intelligence audience and the member may provide feedback such as the following: Overall assessment: “CARBONE” is consistently visible, both on the jar and the wall, ensuring that viewers associate the images and experiences depicted with the specific brand.

Areas of Improvement: The image of the brick wall with “WINES” might be a bit ambiguous for some viewers. It provides ambiance but doesn't directly communicate the benefits or qualities of the product.

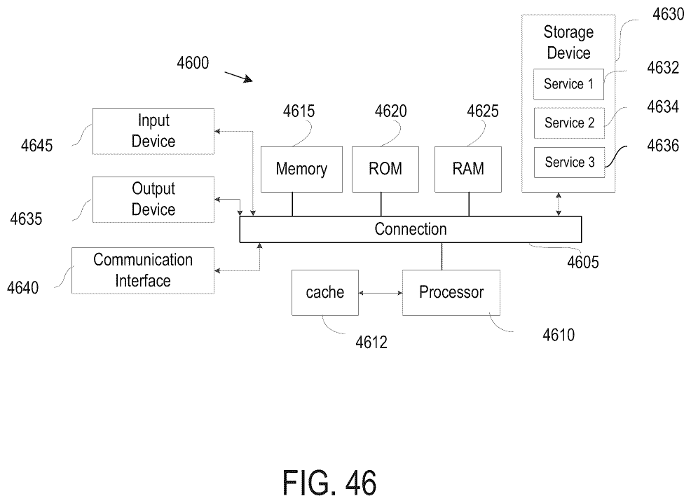

FIG. 46 shows an example of computing system 4600, which can be, for example, any computing device making up the computing device such as the client computing device 102, the server computing device 104, or any component thereof in which the components of the system are in communication with each other using connection 4605. Connection 4605 can be a physical connection via a bus, or a direct connection into processor 4610, such as in a chipset architecture. Connection 4605 can also be a virtual connection, networked connection, or logical connection.

In some embodiments, computing system 4600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 4600 includes at least one processing unit (CPU or processor) 4610 and connection 4605 that couples various system components including system memory 4615, such as read-only memory (ROM) 4620 and random access memory (RAM) 4625 to processor 4610. Computing system 4600 can include a cache of high-speed memory 4612 connected directly with, in close proximity to, or integrated as part of processor 4610.

Processor 4610 can include any general purpose processor and a hardware service or software service, such as services 4632, 4634, and 4636 stored in storage device 4630, configured to control processor 4610 as well as a special-purpose processor where software instructions are incorporated into the actual processor design. Processor 4610 may essentially be a completely self-contained computing system, containing multiple cores or processors, a bus, memory controller, cache, etc. A multi-core processor may be symmetric or asymmetric.

To enable user interaction, computing system 4600 includes an input device 4645, which can represent any number of input mechanisms, such as a microphone for speech, a touch-sensitive screen for gesture or graphical input, keyboard, mouse, motion input, speech, etc. Computing system 4600 can also include output device 4635, which can be one or more of a number of output mechanisms known to those of skill in the art. In some instances, multimodal systems can enable a user to provide multiple types of input/output to communicate with computing system 4600. Computing system 4600 can include communications interface 4640, which can generally govern and manage the user input and system output. There is no restriction on operating on any particular hardware arrangement, and therefore the basic features here may easily be substituted for improved hardware or firmware arrangements as they are developed.

Storage device 4630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 4630 can include software services, servers, services, etc., that when the code that defines such software is executed by the processor 4610, it causes the system to perform a function. In some embodiments, a hardware service that performs a particular function can include the software component stored in a computer-readable medium in connection with the necessary hardware components, such as processor 4610, connection 4605, output device 4635, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A system, comprising:
a memory storing computer-readable instructions; and
at least one processor to execute the instructions to:
ingest data from at least one third party data source associated with determining an artificial intelligence audience;
transmit at least one question associated with determining the artificial intelligence audience;
receive a response to each question associated with determining the artificial intelligence audience;
analyze each response to each question associated with determining the artificial intelligence audience;
generate a prompt based on the response to each question and transmit the prompt to a large language model (LLM) application programming interface (API);
receive a response from the LLM API;
generate the artificial intelligence audience based on the response to each question and the LLM API; and
transmit information associated with the artificial intelligence audience, the information comprising at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience.

2. The system of claim 1, wherein the artificial intelligence audience is generated based on characteristics comprising at least one of character driven, mnemonic driven, brand and performance driven, popularity driven, barrier removal driven, future focused, value driven, defender, badge driven, product demonstration driven, influence driven, authority driven, aspirational, feature driven, competitive, fame driven, and advocacy driven.

3. The system of claim 1, the at least one processor further to generate a graphical user interface (GUI) to receive the response to each question associated with determining the artificial intelligence audience.

4. The system of claim 2, the at least one processor further to process a ruleset associated with each of the characteristics and determine whether the response to each question is within a particular range for each characteristic.

5. The system of claim 2, the at least one processor to determine that a rule for a ruleset associated with each of the characteristics is a match and determine that a respective ruleset is a match.

6. The system of claim 1, the at least one processor to determine a variance between an ideal score for a particular question associated with determining the artificial intelligence audience and the response to the particular question.

7. The system of claim 1, the at least one processor further to receive a request to skip one of the at least one question associated with determining the artificial intelligence audience.

8. The system of claim 2, the at least one processor further to order the characteristics based on a number of matching rulesets associated with each of the at least one characteristic.

9. The system of claim 2, the at least one processor further to remove the characteristics having less than two matching rulesets associated with each of the at least one characteristics.

10. The system of claim 2, the at least one processor to select six or fewer characteristics based on a number of matching rulesets associated with each of the characteristics.

11. The system of claim 1, wherein the LLM API has access to data from at least one third party data source associated with the artificial intelligence audience comprising demographic data, search data, social sensing data, and advertising effectiveness research data.

12. The system of claim 1, the at least one processor further to store each response to each question in an artificial intelligence database.

13. The system of claim 12, the at least one processor further to generate an artificial intelligence engine based on the artificial intelligence database and the at least one third party data source.

14. The system of claim 1, the at least one processor further to generate the at least one generative image of a headshot of the member of the artificial intelligence audience.

15. The system of claim 1, the at least one processor further to generate audio of the demographic information and output the audio of the demographic information as read by the member of the artificial intelligence audience having a particular voice associated with the response to each question.

16. The system of claim 1, the at least one processor further to generate audio of the personality information and output the audio of the personality information as read by the member of the artificial intelligence audience.

17. The system of claim 1, the at least one processor further to generate audio of a response to the input from the user and output the audio of the response to the input as read by the member of the artificial intelligence audience.

18. The system of claim 1, the at least one processor further to generate a tone of voice (TOV) for the member of the artificial intelligence audience and use the TOV to generate the demographic information and the personality information.

19. A method, comprising:
ingesting, by at least one processor, data from at least one third party data source associated with determining an artificial intelligence audience;
transmitting, by the at least one processor, at least one question associated with determining the artificial intelligence audience;
receiving, by the at least one processor, a response to each question associated with determining the artificial intelligence audience;
analyzing, by the at least one processor, each response to each question associated with determining the artificial intelligence audience;
generating, by the at least one processor, a prompt based on the response to each question and transmitting the prompt to a large language model (LLM) application programming interface (API);
receiving, by the at least one processor, a response from the LLM API;
generating, by the at least one processor, the artificial intelligence audience based on the response to each question and the LLM API; and
transmitting, by the at least one processor, information associated with the artificial intelligence audience, the information comprising at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience.

20. A non-transitory computer-readable storage medium, having instructions stored thereon that, when executed by a computing device cause the computing device to perform operations, the operations comprising:
ingesting data from at least one third party data source associated with determining an artificial intelligence audience s;
transmitting at least one question associated with determining the artificial intelligence audience;
receiving a response to each question associated with determining the artificial intelligence audience;
analyzing each response to each question associated with determining the artificial intelligence audience;
generating a prompt based on the response to each question and transmitting the prompt to a large language model (LLM) application programming interface (API);
receiving a response from the LLM API;
generating the artificial intelligence audience based on the response to each question and the LLM API; and
transmitting information associated with the artificial intelligence audience, the information comprising at least one generative image of a member of the artificial intelligence audience, demographic information associated with the member of the artificial intelligence audience, personality information associated with the member of the artificial intelligence audience, and a text box to receive input from a user to allow the user to ask at least one realtime query to the member of the artificial intelligence audience.
